(19) United States
(12) Patent Application Publication
(10) Pub. No.: US 2020/0074565 A1
(43) Pub. Date: Mar. 5, 2020

(54) AUTOMATED ENTERPRISE TRANSACTION DATA AGGREGATION AND ACCOUNTING

(71) Applicant: MX Technologies, Inc., Lehi, UT (US)

(72) Inventor: James Dotter, Lehi, UT (US)

(73) Assignee: MX Technologies, Inc., Lehi, UT (US)

(21) Appl. No.: 16/559,396

(22) Filed: Sep. 3, 2019

Related U.S. Application Data
(60) Provisional application No. 62/726,196, filed on Aug. 31, 2018.

(51) Int. Cl. G06Q 40/00; G06Q 40/02

(52) U.S. Cl. CPC G06Q 40/125; G06Q 40/025; G06Q 40/123

(57) ABSTRACT

Apparatuses, systems, methods, and computer program products are presented for automated enterprise transaction data aggregation and accounting. A hardware computer server is configured to create metadata records for a plurality of transactions for one or more accounts. A hardware computer server is configured to determine a category for each of the transactions based on the metadata records. A hardware computer server is configured to select an offer for a product based on determined categories and created metadata records. Computer executable program code installed on a non-transitory computer readable storage medium of a hardware device comprises operations configured to receive, from a network interface of a hardware computer server over a network interface of the hardware device, an offer for a product and to display the offer for a product to a user on an electronic display of the hardware device.

### CROSS-REFERENCES TO OTHER APPLICATIONS

This application claims the benefit of U.S. Provisional Patent Application No. 62/726,196 entitled “AUTOMATED ENTERPRISE TRANSACTION DATA AGGREGATION AND ACCOUNTING” and filed on Aug. 31, 2018, for James Dotter, which is incorporated herein by reference in its entirety for all purposes.

### FIELD

This invention relates to enterprise transaction data and more particularly relates to automated aggregation and accounting of enterprise transaction data.

### BACKGROUND

Accountants and other tax professionals are often relegated to boxes of receipts and bank statements to prepare reports and tax returns. Such records are often incomplete, or may be inaccurately transcribed, leading to errors.

### SUMMARY

Apparatuses are presented for enterprise transaction data aggregation and accounting. In one embodiment, a hardware computer server for a financial institution comprises a network interface. A hardware computer server, in certain embodiments, is configured to create metadata records for a plurality of financial transactions for one or more financial accounts of a business entity, including at least one financial account held for the business entity by the financial institution. In some embodiments, a hardware computer server is configured to determine an accounting category for each of a plurality of financial transactions based on metadata records. A hardware computer server, in a further embodiment, is configured to select an offer for a financial product of a financial institution based on determined accounting categories and created metadata records.

In one embodiment, computer executable program code is installed on a non-transitory computer readable storage medium of a hardware device of a user associated with the one or more financial accounts. A hardware device, in some embodiments, includes an electronic display and a network interface. Executable program code, in certain embodiments, includes operations configured to receive an offer for a financial product of a financial institution from a network interface of a hardware computer server using a network interface of a hardware device of a user. In a further embodiment, executable program code includes operations configured to display an offer for a financial product of a financial institution to a user on an electronic display of a hardware device of the user.

Other apparatuses are presented for enterprise transaction data aggregation and accounting. In one embodiment, an apparatus includes means for creating metadata records for a plurality of financial transactions for one or more financial accounts of a business entity including at least one financial account held for the business entity by a financial institution. An apparatus, in a further embodiment, includes means for determining an accounting category for each of a plurality of financial transactions based on metadata records. In certain embodiments, an apparatus includes means for selecting an offer for a financial product of a financial institution based on determined accounting categories and created metadata records. An apparatus, in some embodiments, includes means for displaying an offer for a financial product of a financial institution to a user associated with one or more financial accounts.

Computer program products are presented, with executable code stored by a non-transitory computer readable storage medium with operations for enterprise transaction data aggregation and accounting. An operation, in some embodiments, includes creating metadata records for a plurality of financial transactions for one or more financial accounts of a business entity, including at least one financial account held for the business entity by a financial institution. A metadata record, in one embodiment, includes a transaction amount, a transaction date, a spending category, and/or an entity identifier for one of a plurality of financial transactions. In certain embodiments, an operation includes determining an accounting category for each of a plurality of financial transactions based on metadata records. An operation, in one embodiment, includes selecting an offer for a financial product of a financial institution based on determined accounting categories and created metadata records. In some embodiments, an operation includes displaying an offer for a financial product of a financial institution to a user associated with one or more financial accounts on an electronic display of a hardware device of the user.

Systems and methods are also presented for enterprise transaction data aggregation and accounting. The systems and methods include one or more components of the apparatuses described above and/or one or more operations of the computer program product described above.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A is a schematic block diagram illustrating one embodiment of a system for automated enterprise transaction data aggregation and accounting;

FIG. 1B is a schematic block diagram illustrating a further embodiment of a system for automated enterprise transaction data aggregation and accounting;

FIG. 2 is a schematic block diagram of one embodiment of an enterprise transaction module;

FIG. 3 is a schematic block diagram of a further embodiment of an enterprise transaction module;

FIG. 4 is a schematic block diagram illustrating one embodiment of an organizational chart, a chart of accounts, and accounting categories;

FIG. 5 is a schematic flow chart diagram illustrating one embodiment of a method for automated enterprise transaction data aggregation and accounting; and

FIG. 6 is a schematic flow chart diagram illustrating a further embodiment of a method for automated enterprise transaction data aggregation and accounting.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

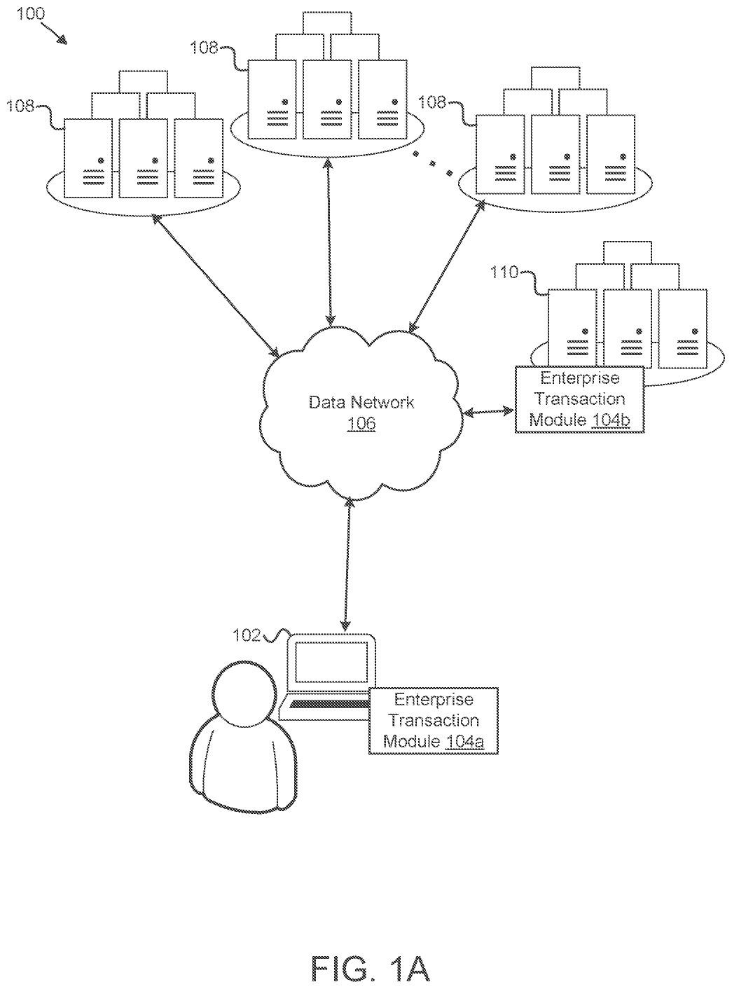

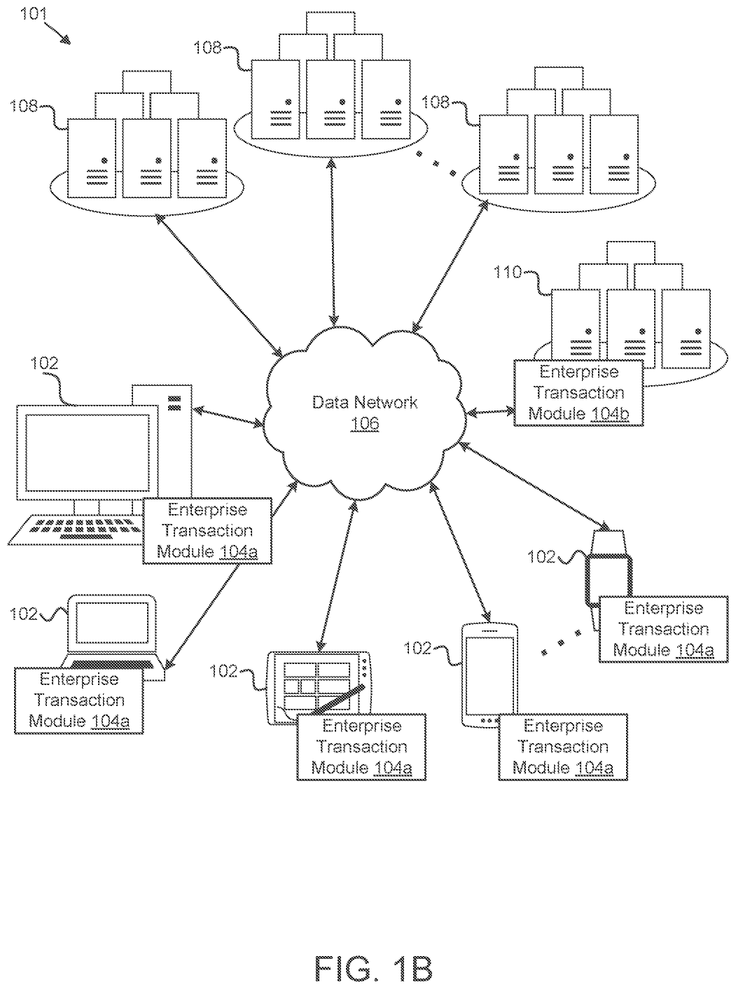

FIG. 1A and FIG. 1B depict embodiments of systems 100, 101 for automated enterprise transaction data aggregation and accounting. In one embodiment, a system 100, 101 includes one or more hardware devices 102, one or more enterprise transaction modules 104 (e.g., a backend enterprise transaction module 104b and/or one or more frontend enterprise transaction modules 104a disposed on the one or more hardware devices 102), one or more data networks 106 or other communication channels, one or more third-party service providers 108 (e.g., one or more servers 108 of one or more service providers 108; one or more cloud or network service providers, or the like), and/or one or more backend servers 110. In certain embodiments, even though a specific number of hardware devices 102, enterprise transaction modules 104, data networks 106, third-party service providers 108, and/or backend servers 110 are depicted in FIG. 1A and/or FIG. 1B, one of skill in the art will recognize, in light of this disclosure, that any number of hardware devices 102, enterprise transaction modules 104, data networks 106, third-party service providers 108, and/or backend servers 110 may be included in a system 100, 101 for automated enterprise transaction data aggregation and accounting.

In general, an enterprise transaction module 104, in certain embodiments, monitors and/or processes electronic financial transaction data for an entity (e.g., a user, a business entity, or the like), and determines an accounting category for each transaction. Based on the transactions and/or the determined accounting categories, in various embodiments, an enterprise transaction module 104 may select an offer for a financial product for the entity (e.g., a bridge loan to cover a determined shortfall, a line of credit with better terms than a current line of credit based on a detected increase in accounts receivable, or the like), may populate and/or file a tax form, may prepare a general ledger, may prepare a financial statement, may prompt a user of a predicted event (e.g., a shortfall, a negative balance, or the like), may transfer funds to prevent a negative balance, and/or automate one or more other accounting tasks quickly and accurately. In some embodiments, an enterprise transaction module 104 may be disposed on a server 110 for a financial institution, and may monitor and/or process the financial institution's transaction data for one or more accounts of the entity (e.g., user, business entity, or the like) held by the financial institution, and/or the enterprise transaction module 104 may aggregate transaction data from one or more third-party service providers 108 for accounts not held by the financial institution, allowing the entity to access automated accounting services directly from the financial institution for one or more held and/or aggregated accounts.

In one embodiment, a system 100, 101 includes one or more hardware devices 102. A hardware device 102 (e.g., a computing device, information handling device, or the like) may include one or more of a desktop computer, a laptop computer, a mobile device, a tablet computer, a smart phone, a set-top box, a gaming console, a smart TV, a smart watch, a fitness band, an optical head-mounted display (e.g., a virtual reality headset, smart glasses, or the like), an HDMI or other electronic display dongle, a personal digital assistant, and/or another computing device comprising a processor (e.g., a central processing unit (CPU), a processor core, a field programmable gate array (FPGA) or other programmable logic, an application specific integrated circuit (ASIC), a controller, a microcontroller, and/or another semiconductor integrated circuit device), a volatile memory, and/or a non-volatile storage medium. In certain embodiments, the hardware devices 102 are in communication with one or more servers 108 of one or more third-party service providers 108 and/or one or more backend servers 110 via a data network 106, described below. The hardware devices 102, in a further embodiment, are capable of executing various programs, program code, applications, instructions, functions, or the like.

In one embodiment, in order to aggregate an entity's transaction data from a third-party service provider 108 or the like (e.g., a different financial institution, a data aggregation server, or the like), an enterprise transaction module 104 may be configured to determine and/or receive an entity's electronic credentials (e.g., username and password, fingerprint scan, retinal scan, digital certificate, personal identification number (PIN), challenge response, security token, hardware token, software token, DNA sequence, signature, facial recognition, voice pattern recognition, bio-electric signals, two-factor authentication credentials, or the like) for one or more third-party service providers 108. The enterprise transaction module 104, in certain embodiments, accesses a server 108 of a third-party service provider 108 using an entity or other user's electronic credentials to download data associated with the user from the server 108, such as financial transaction records or other financial data for the entity and/or other data associated with and/or owned by an entity but stored by a server 108 of a third-party service provider 108 (e.g., stored by hardware not owned, maintained, and/or controlled by the entity, by the financial institution associated with the backend server 110, or the like). The enterprise transaction module 104, in various embodiments, may provide the downloaded data to the user locally (e.g., displaying the data on an electronic display of a hardware device 102); may provide the downloaded data from the hardware device 102 of the user to and/or package the data for a remote server 110 (e.g., a backend enterprise transaction module 104b) or other remote device (e.g., another hardware device 102 of the user, a hardware device 102 of a different user, or the like) which may be unaffiliated with the third-party service provider 108; may provide one or more alerts, messages, offers, advertisements, and/or other communications to the user (e.g., on a hardware device 102) based on the downloaded data; or the like.

In one embodiment, at least a portion of an enterprise transaction module 104 (e.g., a frontend enterprise transaction module 104a or the like) may be integrated with or otherwise part of another application executing on a hardware device 102, such as an enterprise financial management application (e.g., computer executable code for displaying an entity's financial transactions from multiple financial institutions, determining and/or displaying an entity's financial budgets and/or financial goals, determining and/or displaying an entity's account balances, determining and/or displaying an entity's profits and losses, or the like), an accounting application, or the like, which may use data the enterprise transaction module 104 downloads from a server 108 of a third-party service provider 108.

In one embodiment, the enterprise transaction modules 104a may comprise a distributed system 101, with the enterprise transaction modules 104a and/or the associated hardware devices 102 downloading and/or aggregating data substantially independently (e.g., downloading data concurrently or non-concurrently, without a global clock, with independent success and/or failure of components). Distributed enterprise transaction modules 104a may pass messages to each other and/or to a backend enterprise transaction module 104b, to coordinate their distributed aggregation of data for entities and/or other users. In one embodiment, the enterprise transaction modules 104a are decentralized (e.g., hardware devices 102 associated with entities or other users perform one or more aggregation functions such as downloading data), rather than relying exclusively on a centralized server or other device to perform one or more aggregation functions.

In a distributed and/or decentralized system 100, 101, a central entity, such as a backend enterprise transaction module 104b and/or a backend server 110, in certain embodiments, may still provide, to one or more enterprise transaction modules 104a, one or more messages comprising instructions for accessing a server 108 of a third-party service provider 108 using a user's credentials, or the like. For example, a backend enterprise transaction module 104b may provide one or more enterprise transaction modules 104a of one or more hardware devices 102 with one or more sets of instructions for accessing a server 108 of a third-party service 108, such as a location for entering a user's electronic credentials (e.g., a text box, a field, a label, a coordinate, or the like), an instruction for submitting a user's electronic credentials (e.g., a button to press, a link to click, or the like), one or more locations of data associated with a user (e.g., a row in a table or chart, a column in a table or chart, a uniform resource locator (URL) or other address, a coordinate, a label, or the like), and/or other instructions or information, using which the enterprise transaction modules 104a may access and download a user's data.

The one or more enterprise transaction modules 104, in certain embodiments, may provide an interface (e.g., an application programming interface (API)) to provide downloaded and/or aggregated user data from servers 108 of one or more third-party service providers 108 to one or more other entities (e.g., a remote server 110 or other hardware device 102 unaffiliated with the third-party service provider 108, a backend enterprise transaction module 104b, or the like). The interface, in one embodiment, comprises a private interface between enterprise transaction modules 104a of users' hardware devices 102 and one or more backend enterprise transaction modules 104b. For example, this may enable a backend enterprise transaction module 104b to provide a user with access to downloaded and/or aggregated user data at multiple locations, on multiple hardware devices 102, through multiple channels, or the like, even if the user's hardware device 102 which downloaded the data is turned off, out of battery, not connected to the data network 106, or the like. In another embodiment, the interface comprises a public and/or open interface, which may be secured, allowing a user to share the user's downloaded data from an enterprise transaction module 104 to one or more other tools, services, and/or other entities to store, process, and/or otherwise use the data.

In various embodiments, an enterprise transaction module 104 may be embodied as hardware, software, or some combination of hardware and software. In one embodiment, an enterprise transaction module 104 may comprise executable program code stored on a non-transitory computer readable storage medium for execution on a processor of a hardware device 102, a backend server 110, or the like. For example, an enterprise transaction module 104 may be embodied as executable program code executing on one or more of a hardware device 102, a backend server 110, a combination of one or more of the foregoing, or the like. In such an embodiment, the various modules that perform the operations of an enterprise transaction module 104, as described below, may be located on a hardware device 102, a backend server 110, a combination of the two, and/or the like.

In various embodiments, an enterprise transaction module 104 may be embodied as a hardware appliance that can be installed or deployed on a backend server 110, on a user's hardware device 102 (e.g., a dongle, a protective case for a phone 102 or tablet 102 that includes one or more semiconductor integrated circuit devices within the case in communication with the phone 102 or tablet 102 wirelessly and/or over a data port such as USB or a proprietary communications port, or another peripheral device), or elsewhere on the data network 106 and/or collocated with a user's hardware device 102. In certain embodiments, an enterprise transaction module 104 may comprise a hardware device such as a secure hardware dongle or other hardware appliance device (e.g., a set-top box, a network appliance, or the like) that attaches to another hardware device 102, such as a laptop computer, a server, a tablet computer, a smart phone, or the like, either by a wired connection (e.g., a USB connection) or a wireless connection (e.g., Bluetooth®, Wi-Fi®, near-field communication (NFC), or the like); that attaches to an electronic display device (e.g., a television or monitor using an HDMI port, a DisplayPort port, a Mini DisplayPort port, VGA port, DVI port, or the like); that operates substantially independently on a data network 106; or the like. A hardware appliance of an enterprise transaction module 104 may comprise a power interface, a wired and/or wireless network interface, a graphical interface (e.g., a graphics card and/or GPU with one or more display ports) that outputs to a display device, and/or a semiconductor integrated circuit device as described below, configured to perform the functions described herein with regard to an enterprise transaction module 104.

An enterprise transaction module 104, in such an embodiment, may comprise a semiconductor integrated circuit device (e.g., one or more chips, die, or other discrete logic hardware), or the like, such as a field-programmable gate array (FPGA) or other programmable logic, firmware for an FPGA or other programmable logic, microcode for execution on a microcontroller, an application-specific integrated circuit (ASIC), a processor, a processor core, or the like. In one embodiment, an enterprise transaction module 104 may be mounted on a printed circuit board with one or more electrical lines or connections (e.g., to volatile memory, a non-volatile storage medium, a network interface, a peripheral device, a graphical/display interface. The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of an enterprise transaction module 104.

The semiconductor integrated circuit device or other hardware appliance of an enterprise transaction module 104, in certain embodiments, comprises and/or is communicatively coupled to one or more volatile memory media, which may include but is not limited to: random access memory (RAM), dynamic RAM (DRAM), cache, or the like. In one embodiment, the semiconductor integrated circuit device or other hardware appliance of an enterprise transaction module 104 comprises and/or is communicatively coupled to one or more non-volatile memory media, which may include but is not limited to: NAND flash memory, NOR flash memory, nano random access memory (nano RAM or NRAM), nanocrystal wire-based memory, silicon-oxide based sub-10 nanometer process memory, graphene memory, Silicon-Oxide-Nitride-Oxide-Silicon (SONOS), resistive RAM (RRAM), programmable metallization cell (PMC), conductive-bridging RAM (CBRAM), magneto-resistive RAM (MRAM), dynamic RAM (DRAM), phase change RAM (PRAM or PCM), magnetic storage media (e.g., hard disk, tape), optical storage media, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (NFC) network, an ad hoc network, and/or the like. The data network 106 may include a wide area network (WAN), a storage area network (SAN), a local area network (LAN), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The one or more third-party service providers 108, in one embodiment, may include one or more network accessible computing systems such as one or more web servers hosting one or more web sites, an enterprise intranet system, an application server, an application programming interface (API) server, an authentication server, or the like. The one or more third-party service providers 108 may include systems related to various institutions or organizations. For example, a third-party service provider 108 may include a system providing electronic access to a financial institution, a government agency, a utility company, an email provider, site, a data storage site, an ecommerce site, or another entity that stores data associated with an entity or other user. A third-party service provider 108 may allow users to create user accounts to upload, view, create, and/or modify data associated with the user. Accordingly, a third-party service provider 108 may include an authorization system, such as a login element or page of a web site, application, or similar front-end, where a user can provide credentials, such as a username/password combination, to access the user's data.

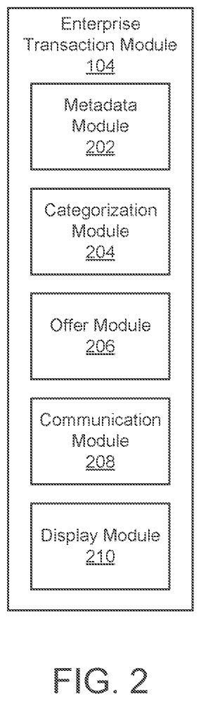

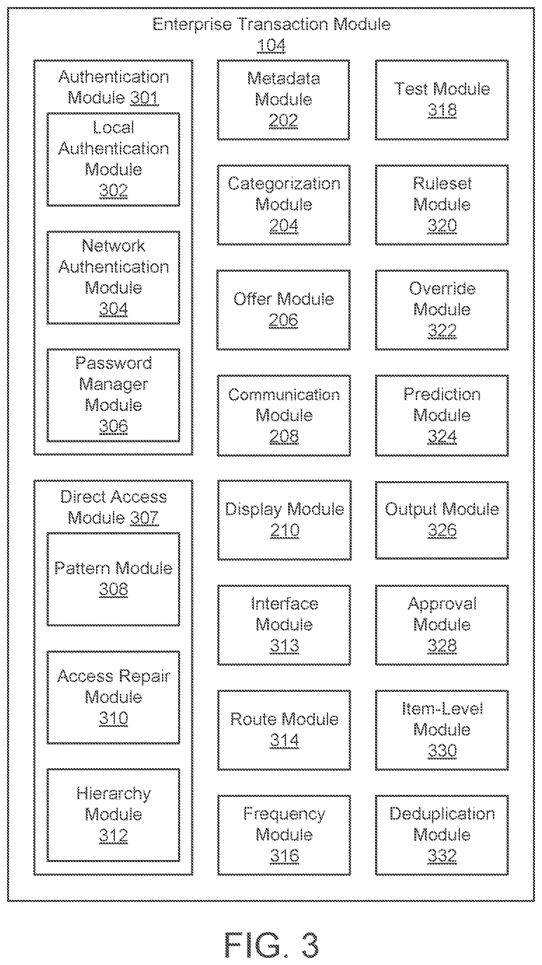

In one embodiment, the one or more backend servers 110 and/or one or more backend enterprise transaction modules 104b provide central management and/or storage for one or more frontend enterprise transaction modules 104a. For example, the one or more backend enterprise transaction modules 104b and/or a backend server 110 may store downloaded user data from the enterprise transaction modules 104a centrally, may provide instructions for the enterprise transaction modules 104a over the data network 106, or the like. A backend server 110 may include one or more servers located remotely from the hardware devices 102 and/or the one or more third-party service providers 108. A backend server 110 may include at least a portion of the modules or sub-modules described below with regard to the enterprise transaction modules 104 of FIG. 2 and/or FIG. 3, may comprise hardware of an enterprise transaction module 104, may store executable program code of an enterprise transaction module 104 in one or more non-transitory computer readable storage media, and/or may otherwise perform one or more of the various operations of an enterprise transaction module 104 described herein.

An enterprise transaction module 104, in certain embodiments, is configured to aggregate transaction data (e.g., financial transaction data, enterprise and/or commercial transaction data, or the like) for one or more entities (e.g., business entities, financial account holders, users, or the like). Enterprise and/or commercial transaction data may include data records for business purchases, payroll records (e.g., payments), revenue transactions (e.g., customer purchases from the entity, customer payments to the entity, or the like), cash withdrawals, credit card transactions, reimbursement requests and/or payments, invoices (e.g., invoices from the business entity, invoices to the business entity, or the like), receivables, payables, equity grants, equity purchases, investor transactions, dividends, interest, insurance, salaries, notes, depreciation expenses, and/or other data associated with a business entity or other user.

An enterprise transaction module 104 may cleanse, categorize, and/or classify aggregated transaction data for a business entity. In certain embodiments, an enterprise transaction module 104 may map an enterprise and/or commercial transaction for a user (e.g., a business entity) to a general ledger (GL) code or other accounting category. An enterprise transaction module 104 may receive one or more transaction mappings from a user (e.g., an administrator or other user associated with a business entity, or the like). For example, a user may provide an enterprise transaction module 104 with one or more mappings and/or vectors from a category and/or classification (e.g., nature of a transaction) to a GL code or other accounting category, from a payee and/or third-party to a GL code or other accounting category, from an account and/or account type to a GL code or other accounting category, or the like. In a further embodiment, an enterprise transaction module 104 may determine one or more transaction mappings in an automated manner (e.g., based on one or more previous mappings by a user, using machine learning or other artificial intelligence, based on a ruleset, or the like).

In some embodiments, an enterprise transaction module 104 is provided by and/or otherwise associated with a financial institution such as a bank, credit union, or the like, and is configured to process enterprise and/or commercial transactions of business entity account holders of the financial institution. Instead of exporting enterprise and/or commercial transactions from the financial institution and entering them into an enterprise resource planning (ERP) system, or requiring the ERP to aggregate enterprise and/or commercial transactions itself from the financial institution, the financial institution may provide the enterprise transaction module 104 to collect, store, manage, process, and/or interpret enterprise and/or commercial transactions or other business data for business entity users (e.g., account holders) of the financial institution.

A financial institution, in one embodiment, may be in a better position to cleanse, categorize, and/or map enterprise and/or commercial transaction data to GL codes and/or other accounting categories than a third-party service provider 108 (e.g., a financial institution may have access to more data associated with a transaction, may receive transaction data earlier than a third-party, may have a larger transaction history, or the like). Further, a financial institution, in some embodiments, may have the added ability to provide a financial product to a business entity based on a prediction of an enterprise transaction module 104 (e.g., a bridge loan during a projected shortfall, a loan with amended covenants before a predicted breach, a better performing investment account, or the like).

In certain embodiments, an enterprise transaction module 104 may provide an interface (e.g., an application programming interface (API), another network interface, a graphical user interface (GUI), a command line interface (CLI), or the like) to one or more third-party service providers 108, one or more business entities or other users, or the like over which the enterprise transaction module 104 may provide enterprise and/or commercial transaction data, cleansed and/or categorized transaction data, enterprise and/or commercial transaction data mapped to GL codes and/or other accounting categories, or the like. For example, an enterprise transaction module 104 may integrate with and/or otherwise provide data access to a third-party ERP or other third-party software, third-party service provider 108, or the like (e.g., the enterprise transaction module 104 may map one or more enterprise and/or commercial transactions to GL codes and/or other accounting categories and load the mapped transactions into an ERP by GL code, or the like).

A business entity may use data received from an enterprise transaction module 104 for accounting, for determining quotes or bids, for a financial statement, or the like. In some embodiments, an enterprise transaction module 104 may dynamically generate and/or populate a tax form, a financial statement, a general ledger, or the like for a business entity, based on aggregated transaction data and determined accounting categories for the aggregated transaction data.

A transaction, as used herein, may comprise a detected and/or recorded electronic occurrence or the like associated with a business entity and/or another user, a user's hardware device 102, a user's account, or the like. A transaction, in various embodiments, may occur on and/or may be detected and/or recorded by an enterprise transaction module 104, a service provider 108, a backend server 110, a hardware device 102 of a user, or the like. For example, in various embodiments, a transaction may comprise one or more of a credit or debit card payment, a direct deposit, an electronic bill payment, a check payment, a cash payment, an automated clearing house (ACH) payment, an online and/or electronic funds transfer (EFT), a wire transfer, a mobile and/or wireless payment, an invoice, an accrual, a transfer between accounts, a payroll payment, a withdrawal, a revenue transaction, a reimbursement, a receivable, a payable, a salary payment, an equity grant, an equity purchase, an investment, a dividend, an interest payment, a loan payment, an insurance payment, a depreciation expense, or the like.

A repeating transaction may comprise an event that occurs more than once. Different occurrences of a repeating transaction, in certain embodiments, may comprise at least one attribute in common (e.g., and/or may have one or more attributes that are different). For example, different occurrences of a repeating transaction may be associated with the same service provider 108, website, and/or other entity; may occur on or around the same time, periodically (e.g., at or around the same time each day; on the same day and/or within a few days each week, month, quarter, year, or other time period; or the like); may be associated with the same or similar (e.g., within a predefined percentage or amount) transaction amount; and/or have one or more other similarities. An enterprise transaction module 104 may be configured to select one or more repeating transactions having at least a threshold number of similarities, may only select one or more repeating transactions having one or more required similarities, or the like. In one embodiment, an enterprise transaction module 104 may provide an interface (e.g., a graphical user interface (GUI), an application programming interface (API), a command line interface (CLI), and/or another interface) allowing a user (e.g., an end user on a hardware device 102, an administrator of a backend server 110, or the like) to select or otherwise define one or more rules for the enterprise transaction module 104 to identify one or more repeating transactions, such as a rule defining a threshold number of similarities for a repeated transaction, a rule requiring one or more similarities for a repeated transaction, a rule allowing one or more differences for a repeated transaction, or the like.

In certain embodiments, a recurring transaction is a type of repeated transaction with one or more predefined similarities, such as a repeated transaction that occurs on or around the same time during each of a plurality of time periods (e.g., at or around the same time each day; on the same day and/or within a few days each week, month, quarter, year, or other time period; or the like) and/or is associated with the same or similar (e.g., within a predefined percentage or amount) transaction amount, or the like. In one embodiment, an enterprise transaction module 104 may be configured to identify any repeating transaction (e.g., including recurring and non-recurring events/transactions).

FIG. 2 depicts one embodiment of an enterprise transaction module 104. In the depicted embodiment, the enterprise transaction module 104 includes a metadata module 202, a categorization module 204, an offer module 206, a communication module 208, and a display module 210.

In one embodiment, the metadata module 202 is configured to create metadata records for one or more financial transactions (e.g., for one or more financial accounts of a business entity and/or other user, for at least one financial account held for a business entity and/or other user by a financial institution, for at least one financial account held for a business entity and/or other user by a third-party financial institution 108 and aggregated, or the like). A metadata module 202, in one embodiment, may process financial transaction data held by a financial institution (e.g., stored in a database, a non-volatile storage device, and/or other data storage for the financial institution) in order to create metadata records. In this manner, in some embodiments, a metadata module 202 installed on a server 110 for a financial institution, may use the financial institution's own held data to determine metadata records for financial transaction data of the financial institution's users/customers (e.g., in order to provide automated general ledger, accounting, and/or tax preparation services for the users/customers).

In a further embodiment, a metadata module 202 may process financial transaction data downloaded and/or aggregated from a server 108 of a third-party service provider (e.g., a third-party financial institution, a third-party data aggregator, or the like) in order to create metadata records. In some embodiments, a metadata module 202 may process financial transaction data for accounts of a business entity and/or other user from both held data of a financial institution and aggregated data from one or more third-party financial institutions, or the like.

A metadata module 202 may access financial transaction data held by a financial institution directly from a database, data file, or other data structure on a computing device 110 and/or server 110 local to the enterprise transaction module 104 (e.g., on a same computing device 110 as the metadata module 202, on a different computing device 110 but on a same local data network 106, on a remote computing device 110 and/or wide area network 106 using electronic credentials for the financial institution, or the like). A metadata module 202, in a further embodiment, may access financial transaction data for a third-party financial institution 108 from a server 108 for the third-party financial institution 108 (e.g., over a wide area network data network 106, using an API data connection of the third-party financial institution 108, or the like).

In some embodiments, a metadata module 202 may access financial transaction data for one or more financial institutions from a server 108 of a third-party data aggregator (e.g., which may comprise an intermediary, downloading financial transaction data from the one or more financial institutions and providing the downloaded data to the metadata module 202, or the like). A metadata module 202 and/or a third-party data aggregator server 108, in one embodiment, may comprise and/or be in communication with a direct access module 307, as described below with regard to FIG. 3, to login to a financial institution on behalf of a business entity and/or other user and to download financial transaction data for the business entity and/or other user.

Metadata records, as used herein, comprise additional data describing and/or created for financial transaction data. For example, in various embodiments, a metadata module 202 may parse downloaded financial transaction data to generate metadata records comprising a transaction amount, a transaction date, a spending category, an entity identifier, a classification of whether a financial transactions is a recurring transaction and/or subscription, an account identifier, a transaction type, and/or other metadata for a financial transaction.

In one embodiment, a metadata record determined by a metadata module 202 may include a transaction amount for a financial transaction, such as a payment amount, a sale amount, a purchase amount, a credit amount, a debit amount, a deposit amount, a withdrawal amount, an RDC amount, a paycheck amount, a direct deposit amount, a loan amount, an invoice amount, an accounts receivable amount, an accounts payable amount, or the like. A metadata record determined by a metadata module 202, in some embodiments, may include a transaction date for a financial transaction, such as a payment date, an invoice date, a closing date, or the like. In a further embodiment, a metadata record determined by a metadata module 202 may include a spending category for a financial transaction (e.g., a type of transaction, such as home/household, mortgage, automobile/transportation, groceries, business supplies, business services, bills/utilities, medical, miscellaneous, food, dining/restaurants, insurance, gifts/donations, education, entertainment, fees/charges, financial, clothing, home repair, health/fitness, income, investments, children, personal care, pets, shopping, taxes, transfers, travel, and/or other categories or subcategories of spending. A metadata record determined by a metadata module 202, in one embodiment, may include an entity identifier, such as a name and/or other identifier for a payee, a payor, a customer, a vendor, a service provider, an employee, an investor, a shareholder, a user, and/or another party to a financial transaction associated with the metadata record.

In certain embodiments, a metadata record determined by a metadata module 202 may include a classification of whether a financial transaction is a recurring transaction and/or a subscription (e.g., using a flag, a bitmap, a string, and/or another indicator). For example, a recurring transaction may include repeated financial transactions with the same vendor, merchant, financial institution, and/or service provider, paid at or around the same time each time period (e.g., each year, quarter, month, bi-week, week, day, or the like), even if the transaction amounts differ over time (e.g., a subscription, a credit card payment, a loan payment, recurring shipment of goods, insurance, or the like) and a subscription may be a recurring transaction with substantially the same transaction amount (e.g., within or around a predefined range, or the like) (e.g., an online service subscription, a software subscription, a printed publication subscription, a membership, or the like).

A metadata record determined by a metadata module 202, in some embodiments, may include an account identifier for an associated financial transaction, such as an account number, an account name, a credit card number, a credit card name, or the like for an account associated with the financial transaction (e.g., an account from which a payment/transfer was made, an account that received a payment/transfer, or the like). In one embodiment, a metadata record determined by a metadata module 202 may include a transaction type for an associated financial transaction (e.g., whether the financial transaction was a credit card transaction, a debit card transaction, a cash transaction, a wire transfer transaction, an ACH transaction, an EFT transaction, an invoice, an accrual transaction, an account transfer transaction, a mobile payment transaction, or the like). In certain embodiments, a metadata record determined by a metadata module 202 may comprise a geographic location for a financial transaction (e.g., an address, geographic coordinates such as latitude and longitude, a merchant and/or store number, and/or another geographic location). In other embodiments, a metadata module 202 may determine other metadata records for financial transaction data.

A metadata module 202, in one embodiment, may process financial transaction data that comprises a string of computer readable characters to determine a metadata record for the financial transaction data. The string of computer readable characters may be at least partially nonsensical and/or difficult for a human user to understand or decipher (e.g., at least partially comprising numeric codes, ASCII codes, and/or other computer readable characters).

In some embodiments, a metadata module 202 may cleanse a financial transaction (e.g., convert a computer readable string to a human readable string), determine a category of a financial transaction, and/or determine a classification of a financial transaction. For example, a metadata module 202 may cleanse a string describing a financial transaction (e.g., an electronic record) by removing one or more alphanumeric and/or other symbols or characters, identified by the metadata module 202 as extraneous, nonsensical, or the like from the string, which may comprise a clustered description of a specific merchant or other party to a transaction. A metadata module 202, in one embodiment, while removing extraneous characters from a transaction description, may use the extraneous characters to identify a specific merchant and/or other party to the transaction (e.g., based on prior use, a transaction history, or the like).

For example, a string describing a transaction may be represented as “56902 ABCXYZ PAYMENT 56902 8756250331” or the like. A metadata module 202 may remove extraneous information to help a business entity or other user to better identify the merchant or other party from the transaction description, such that the merchant or other party is readily recognizable. In the example above, the metadata module 202 may cleanse the description to “ABCXYZ Company,” which a user may readily recognize, for example, as its mortgage lender or the like. The metadata module 202 may adapt and may automatically customize descriptions based on a business entity or other user's history, such that as recurring or repeating descriptions are posted the metadata module 202 recognizes the description of the merchant or other part and consistently identifies it accordingly. In some embodiments, a metadata module 202 may cleanse, categorize, and/or classify a financial transaction before presenting the transaction and/or any associated transaction data to a business entity or other user.

In a further embodiment, a metadata module 202 may match indexable strings based on patterns and allow lookup of matches to take significantly less time than other algorithms. In some embodiments, a metadata module 202 may increase string matching speeds and limit access to nonvolatile storage by using one or more Bloom filters, or the like. A metadata module 202 may use one or more Bloom filters to determine presence of a match in the dataset before referencing the index at all. Through these techniques, the metadata module 202 may reduce a seek time for a unique pattern in a large dataset to between O(1) and O(log(n)).

In some embodiments, a Bloom filter may indicate to a metadata module 202 whether a string to be matched is present in the database to be searched. If the string to be matched is not present, then accessing the database can be omitted, saving time. If the Bloom filter is kept in volatile memory (e.g., DRAM, SRAM or the like), additional speed savings can be obtained.

A Bloom filter is a space-efficient probabilistic data structure that a metadata module 202 may use to test whether an element (e.g., a string describing a financial transaction) is a member of a set (e.g., a set of previous matches, a set of known merchants/vendors, or the like). In some embodiments, false positive retrieval results with a Bloom filter may be possible, but false negatives may not be (e.g., a query may return either “may be inside set” or “definitely not in set”).

An empty Bloom filter may be a bit array of m bits, set to 0. There may be k different hash functions defined, each of which maps or hashes some set element to one of the m array positions with a uniform random distribution, or the like. To add an element, a metadata module 202 may feed it to each of the k hash functions to get k array positions, and set the bits at the positions to 1, or the like.

To query for an element (e.g., test whether the element is in the set), a metadata module 202 may feed it to each of the k hash functions to get k array positions. If any of the bits at these positions is 0, the element is not in the set. If the element were in the set, then the bits would have been set to 1 when it was inserted. If the bits are 1, then either the element is in the set, or the bits have by chance been set to 1 during the insertion of other elements (e.g., a hashing collision has occurred), resulting in a false positive. In some embodiments of a Bloom filter, there may be no way to distinguish between a positive result and a false positive. In other embodiments, a more advanced Bloom filter may use collision handling techniques to manage and/or avoid false positives.

In some embodiments, the requirement of designing k different independent hash functions may be prohibitive for large k. For a good hash function with a wide output, in certain embodiments, there may be little if any correlation between different bit-fields of such a hash, so this type of hash may be used to generate multiple “different” hash functions by slicing its output into multiple bit fields. In other embodiments, one may pass k different initial values (such as 0, 1, . . . , k−1) to a hash function that takes an initial value; add (or append) these values to the key; or the like. For larger m and/or k, in certain embodiments, independence among the hash functions may be relaxed with negligible increase in false positive rate.

In one embodiment, removing an element from a simple Bloom filter may not be supported because false negatives may not be permitted. For example, an element may map to k bits, and although setting any one of those k bits to zero may suffice to remove the element, it may also result in removing other elements that happen to map onto that bit. Since there may be no way to determine whether another element has been added that affects the bits for an element to be removed, clearing a bit may introduce the possibility for a false negative.

In certain embodiments, a metadata module 202 may simulate one-time removal of an element from a Bloom filter by maintaining a second Bloom filter that includes items that have been removed. However, false positives in the second filter may become false negatives in the composite filter, which may be undesirable. In this approach, re-adding a previously removed item may not be possible, as one may have to remove it from the “removed” filter. In some embodiments, when a false positive rate gets too high, a metadata module 202 may regenerate the filter.

Bloom filters, in some embodiments, may have a space advantage over certain other data structures for representing sets. Linked structures may incur an additional linear space overhead for pointers. In one embodiment, a Bloom filter with about a 1% error rate and an optimal value of k, in contrast, may use about 9.6 bits per element, regardless of the size of the elements. In a further embodiment, adding about 4.8 bits per element may decrease the error rate by about ten times.

Bloom filters, in some embodiments, may also have the unusual property that the time needed either to add items or to check whether an item is in the set may be a fixed constant, O(k), completely independent of the number of items already in the set. In a hardware embodiment, a Bloom filter's k lookups may be independent and may be parallelized.

A speed of accessing a particular data item, in one embodiment, may be increased by use of a searchable index or database index. A database index, as used herein, is a data structure that improves the speed of data retrieval operations on a database table. A database index may increase data retrieval speeds at the cost of slower writes and less storage space, or the like. A database index may be created using one or more columns of a database table, providing the basis for both rapid random lookups and efficient access of ordered records. A database index, in some embodiments, tells the computer where in the database to look for the string in question, reducing disk access and thus search time.

Suppose a data store contains N data objects, and it is desired to retrieve one of them based on the value of one of the object's fields. A naive implementation would retrieve and examine each object until a match was found. A successful lookup would retrieve half the objects on average; an unsuccessful lookup all of them for each attempt. This means that the number of operations in the worst case is O(N) or linear time. Since data stores commonly contain millions of objects and since lookup is a common operation, in some embodiments, it may be desirable to improve on this performance.

An index, as used herein, includes any data structure that improves the performance of data record lookup and/or retrieval. There are many different data structures which may be used for this purpose. There are design trade-offs involving lookup performance, index size, and index update performance, but some index designs may exhibit logarithmic (O(log(N))) lookup performance and in some applications, it may be possible to achieve flat (O(1)) performance.

For an entity, such as a financial institution, business entity, library, research institution, university, government agency, or the like that matches large datasets against other large datasets based on patterns, a metadata module 202 may save a significant amount of processing time and needed hardware/software for associating data processing. The addition of a presence of one or more Bloom filters and a searchable index may further improve performance speed.

A simplified example of one technique which a metadata module 202 may use is as follows:

Input string to match against dataset:

“APL*APPLE iTUNES STOR xxxxxxxx7753 CA 12/30”

In the provided embodiment, elements of the input string include white space, number patterns, non-alphabetic characters (symbols), and alphabetic text. One derivation of the transformation of this string into a pattern for matching is as follows:

Replace non-alpha/non-space/non-numeric characters with a space:

“APL APPLE iTUNES STOR xxxxxxxx7753 CA 12 30”

Replace repeating white space with a single space:

“APL APPLE iTUNES STOR xxxxxxxx7753 CA 12 30”

Replace numeric characters with #:

“APL APPLE iTUNES STOR xxxxxxxx#### CA ## ##”

Replace all repeating # which a single #:

“APL APPLE iTUNES STOR xxxxxxxx# CA # #”

Standardize the capitalization (uppercase or lowercase):

“APL APPLE ITUNES STOR xxxxxxxx# CA # #”

This pattern, as processed by a metadata module 202, may be used in a unique index using known patterns for unique index matching and sorting/searching (e.g., which may return “Apple iTunes Store” or another standardized string). In some embodiments, the standardized transformation into a pattern-based string allows a unique index to match a “fuzzy” pattern without having to calculate the “distance” or “fuzzy match” quotient as the pattern derived from a new input string must match exactly to be considered a match.

Utilizing this method in combination with presence (Bloom) filters, in certain embodiments, allows a metadata module 202 to determine the presence of a pattern or string to be searched before accessing the database, to avoid reading the index from non-volatile storage, saving even more time. For example, steps that may be performed by a metadata module 202, in various embodiments, may include accepting a sequence to be matched against a set of data in a database, performing a standardized transformation of the sequence into a pattern-based string, using a Bloom filter to determine whether the pattern-based string is present in the database, and if the pattern-based string is present in the database, then using a searchable index to determine where in said database to look for the pattern-based string, looking for the pattern-based string in the database based on information from the searchable index, and returning an answer whether the pattern-based string has a match in the database.

In some embodiments, a metadata module 202 may append metadata records to the same financial transaction data associated with the metadata records (e.g., to the same database table, the same data file, or the like). In another embodiment, a metadata module 202 may store metadata records separately from financial transaction data, but associated with the financial transaction data (e.g., in a separate database table, database, file, and/or other data structure, but associated by a unique identifier, primary/secondary key, index, mapping, or the like).

In one embodiment, the categorization module 204 is configured to determine an accounting category (e.g., a general ledger code and/or account, or the like) for financial transactions based on metadata records from the metadata module 202. An accounting category, as used herein, comprises a class or division of financial transactions based on a shared characteristic of the financial transactions (e.g., similar metadata records, or the like). In one embodiment, accounting categories may comprise general ledger codes and/or accounts for a business entity or other user (e.g., a collection of multiple ledger accounts for the business entity or other user). For example, a categorization module 204 may add each of a plurality of financial transactions to an accounting category (e.g., an account in a general ledger) as a credit or a debit. A categorization module 204 may use default accounting categories (e.g., a default chart of accounts, default general ledger codes, or the like), and/or provide a user interface allowing a user (e.g., an administrator or other user associated with a business entity) to define custom accounting categories (e.g., a custom chart of accounts, custom general ledger codes and/or accounts, or the like).

In some embodiments, a categorization module 204 may automatically derive accounting categories for a business entity or other user based on a hierarchical organizational chart for the business entity or other user. For example, a categorization module 204 may duplicate and/or otherwise repeat a chart of accounts and/or other set of accounting categories for each department, each executive, each partner, each shareholder, each employee, or other entity from the hierarchical organizational chart (e.g., tracking debits and credits for each one in each accounting category, or the like). In certain embodiments, a categorization module 204 may use a default organizational chart and/or provide a user interface allowing a user (e.g., an administrator or other user associated with a business entity) to define a custom organizational chart.

A categorization module 204, in some embodiments, may determine and/or use a ruleset for categorizing financial transactions based on accounting categories (e.g., the categorization module 204 may determine accounting categories for subsequent financial transactions using the same ruleset, may dynamically build and/or update a ruleset over time, or the like). For example, a ruleset for a categorization module 204 may comprise rules and/or other instructions or indicators mapping elements of a metadata record to an accounting category. A categorization module 204 may input a metadata record from a metadata module 202 for a financial transaction into a ruleset (e.g., an index, a mapping structure, a function, a tree, or the like) to determine an accounting category.

Mappings from metadata records to accounting categories, in various embodiments, may be based on user input (e.g., a user defining an accounting category for a financial transaction), based on public records for an identified party to a financial transaction (e.g., state records for a business entity, a website for a business entity, or the like), based on which employee or other user made the financial transaction, based on a machine learning and/or other artificial intelligence analysis of financial transactions for a plurality of business entities or other users, based on a machine learning and/or other artificial intelligence analysis of one or more websites for an identified party to a financial transaction, based on item-level data determined for a financial transaction, or the like. In some embodiments, a categorization module 204 may standardize mappings for multiple users (e.g., multiple business entities) based on merchants or other parties to the financial transactions (e.g., using similar mappings for each financial transaction with the same merchant or other party). In one embodiment, a categorization module 204 may provide a user interface allowing a user to customize mappings from dynamically selectable combinations of different elements of metadata records (e.g., a transaction amount, a transaction date, a spending category, an entity identifier, a classification of whether a financial transactions is a recurring transaction and/or subscription, an account identifier, a transaction type, and/or other metadata for a financial transaction) to dynamically selectable accounting categories, providing flexible custom mapping options for complex accounting.

By dynamically determining accounting categories for each financial transaction of a business entity, in some embodiments, a categorization module 204 may have a dynamic, real time view of the business entity's financial profile and/or state, allowing the financial institution associated with the categorization module 204 to customize services and/or products for the business entity, to provide additional services to the business entity (e.g., dynamically generating a general ledger, a balance sheet, a profit and loss statement, a populated tax form, or the like). In one embodiment, an offer module 206 is configured to select an offer for a financial product of a financial institution based on the accounting categories determined by the categorization module 204 and/or the metadata records determined by the metadata module 202.

A financial product, as used herein, comprises a product and/or service provided by a financial institution to an account holder or other user of the financial institution. For example, in various embodiments, a financial product may comprise a loan, financing a purchase, a savings account, a checking account, an investment account, insurance, accounting services, tax services, generating a general ledger, generating a balance sheet, generating a profit and loss statement, populating a tax form, payroll services, or the like.

In certain embodiments, an offer module 206 may monitor financial transactions, metadata records, and/or accounting categories of a business entity and may predict a future event for the business entity and select a financial product based on the predicted event. For example, an offer module 206 may monitor accounts payable and accounts receivable, account balances, profits and losses, or the like, to predict an event such as a future shortfall of funds, a negative account balance, a future breach of a financial covenant for a loan or other account, a future excess of funds, or the like.

In one embodiment, an offer module 206 may select a financial product comprising a bridge loan for a business entity, in response to predicting a future shortfall of funds. An offer module 206 may select an amount of a bridge loan to cover a predicted future shortfall, and to be paid back by accounts payable funds to be received by the business entity. For example, an offer module 206 may select an offer contingent on a predicted transaction, that the financial institution will provide a bridge loan to a business or other user for up to a determined period of time, up to a determined monetary amount, or the like. In some embodiments, an offer module 206 may allow a business entity or other user to authorize automatic payment of the bridge loan (e.g., in full) in response to a subsequent event (e.g., the determined period of time, a selected accounts receivable payment being received, or the like). In a further embodiment, an offer module 206 may predict a negative account balance, and may offer a financial product comprising a service of automatically transferring funds from a different account to the account predicted to have the negative balance (e.g., to avoid the negative balance or the like).

In response to predicting a future breach of a financial covenant by a business entity, an offer module 206, in some embodiments, may select a financial product comprising an amended financial covenant for an existing financial product and/or account, a new financial account with a different financial covenant, or the like. As used herein, a financial covenant comprises a condition agreed to by a business entity or other user in order to receive a financial product, account, and/or term from a financial institution. For example, a financial covenant may comprise an agreement not to allow one or more balance sheet items, not to allow one or more ratios to fall below or go above a predefined limit, or the like. An offer module 206, in one embodiment, may select the amended financial covenant, the different financial covenant, or the like for the business entity based on metadata records and/or accounting categories for accounts of the business entity (e.g., selected such that the business entity is likely to be able to keep the amended financial covenant, the different financial covenant, or the like).

In certain embodiments, an offer module 206 may dynamically determine a business entity's risk analysis, credit worthiness, and/or ability to pay for a selected financial product of an offer based on financial transaction metadata records and/or accounting categories for the business entity. In some embodiments, an offer module 206 is configured to determine an interest rate, a fee, or the like for an external account of a business entity or other user held by a different financial institution, based on financial transactions aggregated for the external account. A financial product selected by the offer module 206, in one embodiment, may be selected with a better interest rate (e.g., a lower interest rate for a loan, a higher interest rate for an investment account, or the like), lower fees, and/or one or more other better terms than a competing financial product (e.g., loan, account, insurance, or the like) from a different financial institution.

A communication module 208, in certain embodiments, may be configured to communicate data between a backend enterprise transaction module 104b disposed on a backend hardware computer server 110 and a frontend enterprise transaction module 104a disposed on a hardware device 102 of a user. A communication module 208 of a hardware computer server 110 may use a network interface of the hardware computer server 110 to send data over a data network 106 to a network interface of a user's hardware device 102, where a communication module 208 of the user's hardware device 102 receives the data.

A communication module 208 may use a predefined protocol, format, interface, or the like for communicating data between a backend hardware computer server 110 and a user's hardware device 102. A communication module 208, in various embodiments, may communicate financial transaction data, metadata records, accounting categories, offers for financial products, general ledgers, profit and loss statements, autopopulated tax forms, risk analyses, credit scores or other indicators of credit worthiness, account balances, budgets, and/or other data.

For example, in one embodiment, a communication module 208 of a backend enterprise transaction module 104b sends an offer for a financial product selected by an offer module 206 from a network interface of a backend hardware computer server 110 over a data network 106 to a network interface of a hardware device 102 of a user. A communication module 208 of a user's hardware device 102, in certain embodiments, is configured to receive the offer for the financial product of the financial institution from the network interface of the hardware computer server 110 using the network interface of the hardware device 102 of the user.

In one embodiment, a display module 210 is configured to provide a user interface and/or otherwise display data to a user on an electronic display of a hardware device 102 of the user. In certain embodiments, a display module 210 may display an offer for a financial product of a financial institution from an offer module 206 to a user on an electronic display of a hardware device 102 of the user. In further embodiments, a display module 210 may display financial transaction data, metadata records, accounting categories, offers for financial products, general ledgers, profit and loss statements, autopopulated tax forms, risk analyses, credit scores or other indicators of credit worthiness, account balances, budgets, and/or other data received from a communication module 208.

In one embodiment, a display module 210 is configured to notify a user on an electronic display of a hardware device 102 of the user, of a predicted negative balance for an account of the user or an associated business entity. A display module 210, in some embodiments, may provide a user interface for a user to approve a transfer of funds from a different account to an account predicted to have a negative balance, in order to prevent the negative balance or the like.

In certain embodiments, a display module 210 is configured to prompt a user on an electronic display of a hardware device 102 for approval of a payment for an accounts payable financial transaction in response to a categorization module 204 (e.g., disposed on a hardware computer server 110) determining an accounts payable accounting category for the accounts payable financial transaction (e.g., so that an enterprise transaction module 104 may automatically make the payment in response to input from the user approving the payment, or the like).

A display module 210 may display and/or prompt a user on an electronic display of a hardware device 102, in various embodiments, using a push notification, a graphical user interface (e.g., of a mobile application or other computer executable code), an email, a text message, or the like.

FIG. 3 depicts another embodiment of an enterprise transaction module 104. In the depicted embodiment, the enterprise transaction module 104 includes a metadata module 202, a categorization module 204, an offer module 206, a communication module 208, and a display module 210 and further includes an authentication module 301, a direct access module 307, an interface module 313, a route module 314, a frequency module 316, a test module 318, a ruleset module 320, an override module 322, a prediction module 324, an output module 326, an approval module 328, an item-level module 330, and a deduplication module 332.

The authentication module 301, in the depicted embodiment, includes a local authentication module 302, a network authentication module 304, and a password manager module 306. The direct access module 307, in the depicted embodiment, includes a pattern module 308, an access repair module 310, and a hierarchy module 312. The metadata module 202, the categorization module 204, the offer module 206, the communication module 208, and/or the display module 210, in some embodiments, may be substantially similar to one or more of the metadata module 202, the categorization module 204, the offer module 206, the communication module 208, and/or the display module 210 described above with regard to FIG. 2. Portions of the depicted enterprise transaction module 104 (e.g., one or more of the depicted modules or portions thereof) may be disposed on a backend hardware computer server 110 (e.g., for a financial institution), on a hardware device 102 (e.g., of a user associated with a business entity or the like), and/or on a third-party hardware computer server 108 (e.g., a server 108 of a third-party financial institution, a third-party data aggregator, a third-party service provider, or the like).

In one embodiment, the authentication module 301 receives a user's electronic credentials for a third-party service provider 108 (e.g., a third-party financial institution 108 or the like) from the user on a hardware device 102 of the user. In a further embodiment, the authentication module 301 may receive electronic credentials for a different user (e.g., from a different hardware device 102, from a backend enterprise transaction module 104, or the like), which may be encrypted and/or otherwise secured, so that the direct access module 307 may download data for the different user (e.g., downloading data for multiple users from a single user's hardware device 102).

For example, in a distributed/decentralized system 100, 101, if one user's hardware device 102 is turned off, asleep, out of battery, blocked by a third-party service provider 108, or the like, in certain embodiments, an enterprise transaction module 104 on a different user's hardware device 102 and/or on a backend server 110 may download data for the one user, using the one user's electronic credentials, and may send the data to the one user's hardware device 102, may send an alert and/or push notification to the one user's hardware device 102, or the like. In this manner, in one embodiment, a user may continue to aggregate data, receive alerts and/or push notifications, or the like, even if the user's own hardware device 102 is blocked, unavailable, or the like. In cooperation with one or more authentication modules 301, the enterprise transaction modules 104a, 104b, in certain embodiments, may communicate with each other using a secure and/or encrypted protocol, and/or may store electronic credentials in a secure and/or encrypted manner, so that a user may not see and/or access another user's electronic credentials, downloaded data, or other private and/or sensitive data.

In embodiments where an enterprise transaction module 104 comprises hardware (e.g., a semiconductor integrated circuit device such as an FPGA, an ASIC, or the like), the authentication module 301 may comprise dedicated security hardware for storing and/or processing electronic credentials, downloaded data, and/or other sensitive and/or private data, such as a secure cryptoprocessor (e.g., a dedicated computer on a chip or microprocessor embedded in a packaging with one or more physical security measures) which does not output decrypted data to an unsecure bus or storage, which stores cryptographic keys, a secure storage device; a trusted platform module (TPM) such as a TPM chip and/or TPM security device; a secure boot ROM or other type of ROM; an authentication chip; or the like. In another embodiment, the authentication module 301 may store and/or process electronic credentials, downloaded data, and/or other sensitive data in a secure and/or encrypted way using software and/or hardware of a user's existing hardware device 102 (e.g., encrypting data in RAM, NAND, and/or other general purpose storage) with or without dedicated security hardware. In certain embodiments, the authentication module 301 may encrypt and/or secure data (e.g., electronic credentials, downloaded data) associated with a first user that is received by, processed by, and/or stored by a second (e.g., different) user's hardware device 102 (e.g., from the first user's hardware device 102 over the data network 106 or the like), preventing the second user from accessing the first user's data while still allowing the first user's data to be downloaded and/or aggregated from a different user's hardware device 102.

In one embodiment, as described above, electronic credentials may comprise one or more of a username and password, fingerprint scan, retinal scan, digital certificate, personal identification number (PIN), challenge response, security token, hardware token, software token, DNA sequence, signature, facial recognition, voice pattern recognition, bio-electric signals, two-factor authentication credentials, or other information whereby the authentication module 301 may authenticate and/or validate an identity of and/or an authorization of a user.

The authentication module 301, in certain embodiments, may receive different credentials from a user for different accounts of the user with different third-party service providers 108 (e.g., different social networks, different photo sharing sites, different financial institutions) so that the enterprise transaction module 104 may download, aggregate, and/or combine the user's data from the multiple different third-party service providers 108. In one embodiment, the authentication module 301, instead of and/or in addition to receiving one or more passwords or other electronic credentials from a user, may manage and/or determine one or more passwords or other electronic credentials for a user for one or more third-party service providers 108. For example, in certain embodiments, the authentication module 301 may receive an initial set of electronic credentials (e.g., a username and a password) from a user for an account of the user with a third-party service provider 108, and the authentication module 301 may use the initial set of electronic credentials to access the user's account with the third-party service provider 108 to set a new password, determined by the authentication module 301. The authentication module 301, in one embodiment, may determine passwords or other electronic credentials that are more secure than those typically created by and/or memorable to a user (e.g., longer, more numbers, greater variation between capital and lowercase letters, more frequently changed, or the like).

In one embodiment, the local authentication module 302 secures and/or authenticates the user's access to downloaded data, to stored passwords, and/or other data on a user's hardware device 102, transferred to and/or from a user's hardware device 102, or the like. For example, the local authentication module 302 may cooperate with one or more security and/or authentication systems of the user's hardware device 102, such as a PIN, password, fingerprint authentication, facial recognition, or other electronic credentials used by the user to gain access to the hardware device 102. In a further embodiment, the local authentication module 302 may authenticate a user before allowing the interface module 313 to provide the user access to downloaded/aggregated data and/or alerts or other messages. For example, the local authentication module 302 may manage and/or access electronic credentials associated with the enterprise transaction module 104, for a user, and may authenticate the user in response to the user accessing an application and/or service of the enterprise transaction module 104.

In certain embodiments, the local authentication module 302 may encrypt and/or otherwise secure, on a user's hardware device 102, electronic credentials and/or downloaded data associated with a different user, so that the user may not access data associated with the different user, but the different user may access the data once it is transmitted to a hardware device 102 of the different user, to a backend server 110, or the like. Local authentication modules 302 of different hardware devices 102, 110 may cooperate to securely transfer data (e.g., one or more electronic credentials, downloaded data, or the like) over the data network 106, from one hardware device 102, 110 to another hardware device 102, 110. In a further embodiment, the local authentication module 302 may ensure that a user's electronic credentials and/or downloaded data remain on a single hardware device 102 (e.g., are not transmitted on a data network 106), in a secure repository or the like, and are not stored on and/or accessible to a backend server 110, a hardware device 102 of another user, or the like.

In one embodiment, the network authentication module 304 receives and/or stores a user's electronic credentials for one or more third-party service providers 108 on a hardware device 102 of the user, on a backend server 110, or the like. The network authentication module 304, in various embodiments, may receive a user's electronic credentials from the user, from a hardware device 102 of the user, from a backend server 110, or the like. The network authentication module 304 may cooperate with the direct access module 307 to provide a user's electronic credentials to a server 108 of a third-party service provider 108 (e.g., the network authentication module 304 may provide electronic credentials to the direct access module 307 to provide to a server 108, the network authentication module 304 may provide electronic credentials directly to a server 108, or the like).

The network authentication module 304, in certain embodiments, may cooperate with the local authentication module 302 to encrypt and/or otherwise secure a user's electronic credentials for one or more third-party service providers 108, on a hardware device 102 of a user, on a data network 106, on a hardware device 102 of a different user, on a backend server 110, while being provided to a server 108 of a third-party service provider 108, or the like. In a further embodiment, the network authentication module 304 ensures that a user's electronic credentials are only stored on a user's hardware device 102 and sent from the user's hardware device 102 to a server 108 of a third-party service provider 108, and does not store a user's electronic credentials on a backend server 110, on a different user's hardware device 102, or the like. In another embodiment, the network authentication module 304 may securely store (e.g., using secure encryption) a user's electronic credentials for a third-party service provider 108 on a backend server 110, on a different user's hardware device 102, or the like, so that a direct access module 307 may access and/or download data associated with the user, even if the hardware device 102 of the user is unavailable, blocked, or the like, as described below with regard to the route module 314. In certain embodiments, whether the network authentication module 304 and/or the local authentication module 302 allow electronic credentials to be sent to and/or stored by a different user's hardware device 102, a backend server 110, or the like may be based on a setting defined based on user input, so that the user may decide a level of security, or the like.

In one embodiment, the password manager module 306 may manage and/or store electronic credentials of a user for a plurality of third-party service providers 108, so that the direct access module 307 may access and/or download data associated with the user from each of the plurality of third-party service providers 108. The password manager module 306, in certain embodiments, may generate and/or otherwise manage different, secure, credentials for each of a plurality of third-party service providers 108.

The password manager module 306, in one embodiment, may securely store generated credentials for a user on a hardware device 102 of the user, so that the user does not have to remember and enter the generated electronic credentials. For example, in addition to allowing a direct access module 307 to access a third-party service provider 108 using generated electronic credentials, the password manager module 306 may automatically populate one or more interface elements of a form on a webpage with electronic credentials (e.g., a username, a password) of the user, in response to the user visiting the web page in a web browser, or the like, without the user manually entering the electronic credentials. The password manager module 306, in certain embodiments, may periodically update (e.g., regenerate different credentials, such as a different password, and update the user's account with the third-party service provider 108 with the regenerated different credentials) electronic credentials for a user, such as every week, every month, every two months, every three months, every four months, every five months, every six months, every year, every two years, in response to a user request, in response to a request from a third-party service provider 108, and/or over another time period or in response to another periodic trigger.

The password manager module 306, in one embodiment, may synchronize a user's electronic credentials (e.g., provided by the user, generated by the password manager module 306, or the like) across different hardware devices 102, web browsers, or the like of a user. For example, in response to a password manager module 306 and/or the user updating or otherwise changing electronic credentials, the password manager module 306 may propagate the update/change to one or more other password manager modules 306, on different hardware devices 102 of the user, or the like.

In one embodiment, the direct access module 307 accesses one or more servers 108 of one or more third-party service providers 108, from a hardware device 102 of a user and/or from a backend server 110, using a user's electronic credentials from the authentication module 301 (e.g., for the user associated with the hardware device 102, for a different user, or the like). The direct access module 307, in certain embodiments, downloads data associated with a user (e.g., a user's social media posts, a user's photos, a user's financial transactions, or the like) from one or more servers 108 of one or more third-party service providers 108 to a hardware device 102 of a user (e.g., of the user associated with the downloaded data, of a different user for processing and/or for transfer to the hardware device 102 of the user associated with the downloaded data, or the like) and/or to a backend server 110 associated with the direct access module 307, instead of or in addition to downloading the data directly to a hardware device 102 of the user (e.g., based on an availability of the hardware device 102 of the user, to backup the data in a second location, or the like).

The direct access module 307, in certain embodiments, may use a webpage interface of a server 108 of a third-party service provider 108 to access the server 108 using a user's electronic credentials and/or to download data associated with the user. For example, in certain embodiments, the direct access module 307 may download/load a webpage from a server 108 of a third-party service provider 108, enter a username and password or other electronic credentials for a user into textboxes in a form on the webpage, submit the username and password or other electronic credentials using a submit button or other interface element of the webpage, and/or otherwise submit electronic credentials using a website to gain authorized access to data on the server 108 associated with the user. As described below, the pattern module 308 may receive and/or provide instructions enabling the direct access module 307 to access a server 108 (e.g., a location or method for submitting electronic credentials, or the like).

In response to successfully authenticating with and accessing a server 108 of a third-party service provider 108 with a user's electronic credentials, the direct access module 307 may download data associated with the user (e.g., from a user's account or the like) from the server 108, to a hardware device 102 associated with the user, to a backend server 110, to a hardware device 102 of another user downloading the data in proxy for the user, or the like. As described below, in certain embodiments, the pattern module 308 may receive and/or provide instructions enabling the direct access module 307 to download data associated with a user from a server 108 of a third-party service provider 108 (e.g., a URL or other link to a location for the data, a label or other identifier for locating the data within one or more webpages or other data structures, or the like). The direct access module 307, in certain embodiments, may follow instructions from a pattern module 308 to authenticate and/or access data from one or more webpages from a server 108 in a screen scraping manner, parsing one or more webpages to locate an entry location and/or submit electronic credentials; to locate, download, and/or extract data associated with a user; or the like.

In one embodiment, the direct access module 307 sends or otherwise submits electronic credentials and/or receives or otherwise downloads data using an API or other access protocol of a server 108 of a third-party service provider 108. For example, the direct access module 307 may send a request in a format specified by and/or compatible with a server 108 (e.g., an API server 108) of a third-party service provider 108. The sent request may comprise electronic credentials for a user or a portion thereof (e.g., a username and/or a password), a subsequent request may comprise electronic credentials for a user or a portion thereof (e.g., in response to receiving an acknowledgment from the server 108 for the first request, or the like), and/or the direct access module 307 may use a different access protocol of a server 108.

In response to a request for data from the direct access module 307 (e.g., in response to the direct access module 307 authenticating a user using an access protocol of a server 108), a server 108 of a third-party service provider 108 may send and/or return data associated with a user (e.g., in one or more messages, packets, payloads, as a URL or other pointer to a location from where the direct access module 307 may retrieve the data, or the like). The direct access module 307, in various embodiments, may receive data associated with a user directly from a server 108 of a third-party service provider 108 over a data network 106; may receive a pointer, URL or other link to a location of data associated with a user from a server 108 of a third-party service provider 108; may receive data associated with a user from another entity on a data network 106 (e.g., in response to a request from the server 108 of the third-party service provider 108 to the other entity or the like); or may otherwise receive data associated with a user according to an access protocol of a third-party service provider 108.

In one embodiment, a third-party service provider 108 provides a direct access module 307 with an API or other access protocol. In a further embodiment, a direct access module 307 may act as a wrapper for and/or a plugin or extension of, an application of a third-party service provider 108 (e.g., a mobile application), and the application may have access to an API or other access protocol of the third-party service provider 108. In another embodiment, a direct access module 307 may be configured to use an API or other access protocol in a same manner as an application of a third-party service provider 108 (e.g., a mobile application), through observation of the application of the third-party service provider 108 or the like. In certain embodiments, a direct access module 307 may cooperate with an application of a third-party service provider 108, a web browser through which a user accesses services of a third-party service provider 108, or the like to access data associated with a user (e.g., accessing data already downloaded by an application and/or user, accessing a database or other data store of an application and/or web browser, scanning and/or screen scraping a web page of a third-party service provider 108 as a user accesses the web page, or the like).

The direct access module 307, in certain embodiments, may access different third-party service providers 108 in different manners. For example, a first third-party service provider 108 may grant the direct access module 307 with access to an API or other access protocol, while the direct access module 307 may use a web page interface (e.g., screen scraping) to access and download data from a second third-party service provider 108, or the like. In one embodiment, a remote backend server 110 may be associated with a first party service provider 110 (e.g., a vendor and/or provider of an enterprise transaction module 104) and the direct access module 307 may download data associated with a user from both the first party service provider 110 and from one or more third-party service providers 108, aggregating the data together so that the user may access the data in a single interface and/or application. For example, as described below with regard to the interface module 313, the interface module 313 may provide a user access to the user's photos from multiple third-party cloud storage providers 108 within a single photo application, may provide a user with access to the user's personal financial information within a single enterprise financial management application and/or online banking application, may provide a user with access to posts from multiple social networks within a single social networking application, or the like.

The direct access module 307, in certain embodiments, may store downloaded and/or aggregated data independently from the one or more third-party service providers 108. For example, the direct access module 307 may store a user's downloaded and/or aggregated data on a hardware device 102 of the user, on a backend server 110 accessible by the user, or the like. In this manner, in certain embodiments, a user may control and/or access the user's data, even if a third-party service provider 108 closes down or is not available, may use the user's data in any manner desired by the user even if the use is not supported by a third-party service provider 108, or the like.

The direct access module 307, in one embodiment, in addition to and/or instead of downloading data from one or more third-party service providers 108, may upload data to and/or change one or more settings of one or more third-party service providers 108, in response to user input or the like. For example, in embodiments where the data comprises photos, the direct access module 307 may upload a photo from a hardware device 102 of the user to one or more third-party service providers 110 (e.g., a downloaded photo that the user has edited on the hardware device 102 or the like). In embodiments where the data comprises social media posts or other content, the direct access module 307 may receive input from a user (e.g., a photo, a textual post, one or more emoji, a video, a document or other file, or the like) and upload the received input to one or more third-party service providers 108 (e.g., social media sites or the like). In embodiments where the data comprises financial transactions or other financial data, the direct access module 307 may schedule a bill pay or other payment or funds transfer, remotely deposit a check (e.g., by uploading photos of the front and/or back of the check, or the like), and/or perform another action.

The direct access module 307 may update or change a user's account information with a third-party service provider 108, such as an account type or plan, credit card or other payment information associated with an account, a phone number or address or other contact information associated with an account, a password or other electronic credentials for an account, and/or other account information of a user for a third-party service provider 108. The direct access module 307 may update and/or upload data in a substantially similar manner to that described herein for downloading data (e.g., determining a user's electronic credentials for a third-party service provider 108, accessing a server 108 of the third-party service provider 108, uploading and/or providing data to the third-party service provider 108, or the like).

In one embodiment, the pattern module 308 determines an ordered list (e.g., a pattern, a script, or the like) of multiple locations on one or more servers 108 of a third-party service provider 108 for the direct access module 307 to access the server (e.g., which may include locations other than where the data of the user is stored and/or accessible), one or more delays for the direct access module 307 to wait between accessing locations on the server 108, and/or other components of an access pattern for accessing data of a server. Locations, in certain embodiments, comprise independently addressable and/or accessible content and/or assets provided by one or more servers of a third-party service provider 108, or the like, such as webpages, portions of a webpage, images or other data files, databases or other data stores, pages or sections of a mobile application, or the like. The pattern module 308, in one embodiment, determines a pattern/ordered list that contains one or more locations and/or delays that are not necessary for the direct access module 307 to access or use in order to download desired data, but instead, the pattern/ordered list may make it difficult or impossible for the third-party service provider 108 to distinguish between the direct access module 307 accessing a server of the third-party service provider 108 and a user accessing the server of the third-party service provider.

The pattern module 308, in one embodiment, may determine and/or select the multiple locations and/or the one or more delays (e.g., a pattern/ordered list) based on an average pattern or a combined pattern identified in or based on behavior of multiple users accessing a third-party service provider 108 using a web browser, a mobile application, or the like. The pattern module 308, in one embodiment, may monitor one or more users (e.g., for a predetermined period of time or the like) as they access a server of a third-party service provider 108, tracking which links, data, webpages, and/or other locations the one or more users access, how long the one or more users access different locations, an order in which the one or more users access locations, or the like. In certain embodiments, the one or more monitored users may be volunteers, who have provided the pattern module 308 with authorization to temporarily or permanently monitor the users' access, in order to provide a more realistic access pattern for the direct access module 307 to use to access a server of a third-party service provider 108.

In a further embodiment, the pattern module 308 determines and/or selects multiple locations and/or one or more delays between accessing different locations based on a pattern identified in behavior of the user associated with the hardware device 102 on which the pattern module 308 is disposed, accessing the third-party service using a web browser, a mobile or desktop application, or other interface of the user's hardware device 102. For example, the pattern module 308 may comprise network hardware of the user's hardware device 102 (e.g., a network access card and/or chip, a processor, an FPGA, an ASIC, or the like in communication with the data network 106 to monitor data and/or interactions with a server of a third-party service provider 108), a web browser plugin or extension, a mobile and/or desktop application executing on a processor of the user's hardware device 102, or the like. The pattern module 308 may request and receive authorization from the user to monitor the user's activity with regard to one or more servers of one or more third-party service providers 108 from the user's hardware device 102.

The pattern module 308, in certain embodiments, may update a pattern/ordered list over time, based on detected changes in access patterns of one or more users or the like. In one embodiment, the pattern module 308 may coordinate and/or cooperate with the access repair module 310, described below, to update a pattern/ordered list in response to a server 108 of a third-party service provider 108 and/or data associated with a user becoming broken and/or inaccessible.

In one embodiment, the access repair module 310 detects that access to a server 108 of a third-party service 108 and/or data associated with a user is broken and/or becomes inaccessible. The access repair module 310, in certain embodiments, provides an interface to a user allowing the user to graphically identify an input location for the user's electronic credentials, a location of data associated with the user, or the like. For example, the access repair module 310 may provide a GUI, a command line interface (CLI), an API, and/or another interface allowing an end user to identify an input location for electronic credentials, an action for submitting electronic credentials, a location of data, or the like. The access repair module 310, in one embodiment, provides an interface to a user on a hardware device 102 of the user.

In certain embodiments, for example, the access repair module 310 may overlay an interface over one or more pages of a website of a third-party service provider 108 on an electronic display screen of a user's hardware device 102. The access repair module 310 may provide one or more interfaces (e.g., GUIs, CLIs, APIs, overlays, or the like) to multiple users, allowing multiple users to define a repair and/or update for access to a server of a third-party service provider 108 (e.g., in a distributed and/or decentralized manner, from different hardware devices 102 or the like over a network 106).

The access repair module 310, in certain embodiments, may determine and/or display one or more suggestions 504 and/or recommendations 504 for the user, which the user may either confirm or change/correct (e.g., in a basic interface, a standard interface, a beginning user interface, or the like). For example, the access repair module 310 may display one or more interface elements with a suggested location for a user to enter a user name, a suggested location for a user to enter a password, a suggested credential submit action, a suggested location of data associated with the user, and/or one or more other interface elements allowing a user to graphically identify one or more locations within a web site of a third-party service provider 108.

The access repair module 310, in certain embodiments, processes one or more pages of and/or other locations on a server 108 (e.g., one or more websites, web apps, or the like) to determine an estimate and/or prediction of an input location for a user's electronic credentials, an action for submitting a user's electronic credentials, a location of data associated with a user, or the like. In one embodiment, the access repair module 310 may estimate one or more locations and/or actions (e.g., by scanning and/or parsing one or more pages of a website, based on input from other users accessing one or more pages of a website, based on previous interactions of the user with one or more pages of a website, a prediction made using a machine learning and/or artificial intelligence analysis of a website, based on a statistical analysis of historical changes to one or more pages of a website and/or of one or more similar websites, or the like). The access repair module 310 may display to a user in an interface an estimate and/or prediction of an input location for the user's electronic credentials, a location of data associated with the user, or the like so that the user may confirm whether or not the estimate and/or prediction is correct using the interface.

The access repair module 310 may indicate one or more estimated locations and/or actions with an arrow or other pointer to a location; a link or other identifier of a location; a box or other highlighting around a location; by altering text labeling for a location to make the text bold, italic, and/or underlined; or the like. A user, in certain embodiments, may click, select, or otherwise identify a location to either confirm or change/correct a location suggested by the access repair module 310. For example, a user may click or otherwise select an interface element associated with a location and/or action and may click or otherwise select the location and/or perform the action, which the access repair module 310 may record (e.g., automatically populating a text field identifying the location and/or action, recording a macro allowing the action to be automatically repeated without the user, for a different user, or the like).

In certain embodiments, instead of or in addition to a standard, basic, or beginning user interface, the access repair module 310 may provide an advanced interface, for experienced users or the like, with source code of a web site and/or other details of the website. For example, in one embodiment, an advanced access repair interface may allow one or more advanced users to identify one or more locations and/or actions within source code of a website, which may not be visible and/or readily apparent in the website itself. In certain embodiments, the access repair module 310 may provide a user interface element allowing a user to select and/or toggle between a standard user interface or view and an advanced user interface or view.

In one embodiment, the hierarchy module 312 provides the direct access module 307 with an ordered list of multiple different sets of instructions for accessing a server 108 of a third-party service provider 108 using a user's electronic credentials, for downloading data associated with the user, or the like. Each different set of instructions, in certain embodiments, comprises a location for entering a user's electronic credentials, an instruction for submitting the user's electronic credentials, one or more locations of the data associated with the user, or the like.

The hierarchy module 312, in one embodiment, may receive one or more sets of instructions from a backend server 110 (e.g., a backend enterprise transaction module 104b of a backend server 110), from another user hardware device 102 in a peer-to-peer manner (e.g., an enterprise transaction module 104a of a user hardware device 102), from a test module 318, or the like. The hierarchy module 312, in certain embodiments, may receive multiple different sets of instructions already in an ordered list (e.g., a global hierarchical order) based on a history of successful and/or unsuccessful uses of the different sets of instructions by different user hardware devices 102 and/or users, or the like. In one embodiment, the hierarchy module 312 may determine a hierarchy for and/or create an ordered list from multiple different sets of instructions for a single user (e.g., a custom or individualized hierarchy) based on a history of successful and/or unsuccessful uses of the different sets of instructions by the user (e.g., from one or more hardware devices 102 of the user).

The direct access module 104, in one embodiment, may iterate through an ordered list of multiple sets of instructions for accessing a server 108 of a third-party service provider 108, in the order of the list, until one of the sets of instructions is successful and the direct access module 104 is able to access and/or download data from the third-party service provider 108. The hierarchy module 312, in one embodiment, may place a most recent successfully used set of instructions at the top (e.g., as the first set to try). For example, the hierarchy module 312 for a user's hardware device 102 may place a set of instructions for accessing a third-party service provider 108 at the top of a list (e.g., adjusting an order of the list over time) in response to the direct access module 307 successfully accessing and/or downloading data from the third-party service provider 108 using the set of instructions. In certain embodiments, the hierarchy module 312 may receive an ordered list of multiple different sets of instructions for accessing a server 108 of a third-party service provider 108 in a first order (e.g., a global order) and may dynamically adjust and/or rearrange the different sets of instructions over time based on a single user's/hardware device 102's use (e.g., moving a set of instructions up in the list if access using the set of instructions is successful for the user/hardware device 102, moving a set of instructions down in the list if access using the set of instructions is unsuccessful for the user/hardware device 102, or the like).

The hierarchy module 312, in certain embodiments, may be configured to share one or more sets of instructions, an ordered list of multiple sets of instructions, or the like with a hierarchy module 312 of another user's hardware device 102 over a data network 106 (e.g., directly to the other user's hardware device 102 in a peer-to-peer manner, indirectly by way of a backend enterprise transaction module 104b of a backend server 110, or the like). Different sets of instructions may be successful or unsuccessful for different users, in various embodiments, due to different account types, different account settings, different originating systems (e.g., due to a corporate acquisition or the like, different users of the same third-party service provider 108 may have one or more different settings, different access methods, or the like), system changes or upgrades, and/or another difference in accounts, services, or the like for different users of the same third-party service provider 108.

In one embodiment, the interface module 313 provides a user's data downloaded by the direct access module 307, from a hardware device 102 of a user (e.g., of the user associated with the downloaded data, of a different user) to another entity, such as a hardware device 102 of a user associated with the downloaded data (e.g., in response to the data being downloaded by a hardware device 102 of a different user, from one hardware device 102 of a user to another hardware device 102 of the same user), a remote server 110 or other remote device 102 unaffiliated with (e.g., not owned by, operated by, controlled by, or the like) the third-party service provider 108 from which the data was downloaded, or the like. For example, the interface module 313 may provide an API or other interface to provide a user's downloaded and/or aggregated data to a hardware device 102 of the user, to a backend enterprise transaction module 104b, to a backend server 110, to a different third-party service provider 108, to a different/second hardware device 102 of the user, or the like.

In certain embodiments, it may be transparent and/or substantially transparent to a user (e.g., not apparent) which hardware device 102, 110 has downloaded data associated with the user. For example, the interface module 313 may provide downloaded data associated with a user from one hardware device 102 of the user to another hardware device 102 of the user, from a hardware device 102 of the user to a backend server 110 (e.g., from which the user may access the data using a web browser, an application, or the like), from a backend server 110 to a hardware device 102 of the user, or the like, allowing the user to access the data from a different location than the location to which the data was downloaded.

In certain embodiments, the interface module 313 provides a graphical user interface (GUI) on a hardware device 102 of a user, and provides downloaded data associated with the user to the user through the GUI (e.g., allowing the user to view the data directly, providing one or more notifications and/or recommendations to the user based on the data, providing one or more tables or charts to the user based on the data, providing a summary of or one or more statistics related to the data, or the like). The interface module 313, in various embodiments, may provide a GUI to the user from the same hardware device 102 to which the data was downloaded, on a different hardware device 102 than the hardware device 102, 110 to which the data was downloaded, or the like.

For example, in one embodiments, where the data associated with a user comprises photos, the interface module 313 may provide a photo management interface, a photo editing interface, or the like wherein the user may view and/or otherwise access the user's downloaded and/or aggregated photos. In a further embodiment, where the data associated with a user comprises the user's financial transaction history (e.g., purchases and/or other financial transactions downloaded from one or more financial institutions 108 such as banks, credit unions, lenders, or the like), the interface module 313 may provide an enterprise financial management interface, with a list of transactions, one or more budgets, one or more financial goals, a debt management interface, a net worth interface, and/or another enterprise financial management interface wherein the user may view the user's downloaded and/or aggregated financial transaction history, and/or alerts or recommendations based thereon. In another embodiment, where the data associated with a user comprises social media posts, the interface module 313 may provide a GUI comprising a stream, feed, and/or wall of social media posts for the user to view (e.g., downloaded and/or aggregated social media posts from multiple social networks 108, from different contacts or friends of the user, or the like).

The interface module 313, in certain embodiments, may provide one or more access controls to a user, allowing the user to define which devices 102, users, third-party service providers 110, or the like may access which data. For example, the interface module 313 may provide an interface for a user to allow and/or restrict certain mobile applications, certain APIs for third-party services, certain plugins or extensions, certain users, certain hardware devices 102, and/or one or more other entities to access data downloaded for the user from one or more third-party service providers 108 (e.g., with access controls by third-party service provider 108 or other data source, by data type, by entity requesting access, and/or at another granularity). In this manner, the enterprise transaction module 104, in certain embodiments, may comprise a local repository of aggregated data, which one or more other devices 102 and/or services may access and use, with a user's permission.

In one embodiment, the route module 314 determines whether a hardware device 102 of a user is available for the direct access module 307 to download data associated with the user from a server 108 of a third-party service provider 108. The route module 314, in certain embodiments, may access a server 108 of a third-party service provider 108, from a remote backend server 110, using the user's electronic credentials, to download data associated with the user from the server 108 to the remote backend server 110 in response to the route module 314 determining that the hardware device 102 of the user is unavailable. The route module 314, in one embodiment, provides a user one or more alerts (e.g., downloaded data from a third-party service provider 108, a recommendation or suggestion determined based on data from a third-party service provider 108, a notification or other alert based on an event or other trigger detected in data from a third-party service provider 108, or the like) on a hardware device 102 of the user based on the data associated with the user downloaded to the remote backend server 110.

In certain embodiments, the route module 314 maintains and/or stores a list of multiple hardware devices 102 associated with a single user and/or account. In response to determining that one hardware device 102 associated with a user and/or account is unavailable (e.g., powered down, in airplane mode, not connected to the data network 106, or the like), the route module 314 may access a server 108 of a third-party service provider 108 from a different, available hardware device 102 of the user and/or account, may provide one or more notifications or other alerts on a different, available hardware device 102, or the like. The route module 314, in various embodiments, may dynamically route downloading of data for a user from a third-party service provider 108 between multiple hardware devices, such as one or more hardware devices 102 of the user, one or more hardware devices 102 of a different user, one or more backend servers 110, and/or another hardware device, in a secure manner.

The route module 314, in one embodiment, may alternate or rotate between multiple hardware devices 102, 110 (e.g., of the same user, of different users, or the like) for downloading data for the same user from a third-party service provider 108 periodically. For example, rotating and/or alternating devices 102, 110 from which data is downloaded, may decrease a likelihood that the downloading will be misinterpreted as fraudulent or improper. In another embodiment, the route module 314 may download data from the same device 102, 110 (e.g., a primary hardware device 102 of a user, a backend server 110, or the like), which may be authorized and/or identified by the third-party service provider 108 as a trusted device, or the like.

In one embodiment, the frequency module 316 sets a frequency with which the direct access module 307 accesses the server 108 of a third-party service provider 108. The frequency module 316, in certain embodiments, determines a frequency based on input from a remote backend server 110, which may be unaffiliated with the third-party service provider 108 being accessed, so that the remote backend server 110 (e.g., the frequency module 316 executing on the remote backend server 110) determines frequencies for a plurality of direct access modules 307 for different users and/or different hardware devices 102. For example, the frequency module 316 may limit a single user and/or hardware device 102 from accessing the same third-party service provider 108 more than an allowed threshold number of times within a time period (e.g., once every ten minutes, once every half an hour, once every hour, twice a day, three times a day, four times a day, or the like). The frequency module 316, in certain embodiments, limits an access frequency to prevent inadvertent denial of service by a third-party service provider 108, or the like.

The frequency module 316, in certain embodiments, may dynamically adjust a frequency with which a user and/or hardware device 102 may access a third-party service provider 108 over time. For example, the frequency module 316 may monitor access and/or downloads by multiple users (e.g., all users, available users, active users, or the like) to cap or limit a total access and/or download bandwidth for each of the different third-party service providers 108 (e.g., so as not to overwhelm any single third-party service provider 108, or the like). In this manner, in one embodiment, a user and/or hardware device 102 may access and/or download data with a higher frequency when fewer other users and/or hardware devices 102 are accessing and/or downloading data (e.g., low peak times), but may be limited to a lower cap or access frequency when more other users and/or hardware devices 102 are accessing and/or downloading data (e.g., high peak times).

In a further embodiment, the frequency module 316 determines a frequency based on input from a user, allowing the user to set the access frequency independently of other users and/or of a backend server 110. The frequency module 316 may provide a user interface (e.g., a GUI, CLI, API, or the like) allowing a user to set and/or adjust an access frequency for downloading data from one or more third-party service providers 108 using one or more hardware devices 102 (e.g., providing different settings allowing the user to set different access frequencies for different third-party service providers 108, different hardware devices 102 of the user, or the like).

In one embodiment, the test module 318 cooperates with the access repair module 310 to verify whether or not one or more received locations and/or instructions from a user are accurate (e.g., usable to access data from a server of a third-party service provider 108). The test module 318, in certain embodiments, attempts to access a server 108 of a third-party service provider 108 for a plurality of different users (e.g., a sample group or test set), based on an identification the access repair module 310 received from a single user, using electronic credentials of the different users or the like.

The test module 318, in certain embodiments, determines whether data associated with the different users (e.g., a sample group or test set) is accessible using the identification from the single user. The test module 318 may repeatedly attempt to access data from a third-party service provider 108 using identifications which the access repair module 310 received from different users (e.g., on different hardware devices 102 and sent to the test module 318 on a single hardware device 102 over the data network 106, sent to multiple test modules 318 on different hardware devices 102 over the data network 106, sent to a test module 318 on a central backend server 110, or the like).

The test module 318, in one embodiment, provides one or more identifications from a user to other instances of the direct access module 307 (e.g., other test modules 318) for accessing a server 108 of a third-party service provider 108 in response to an amount of the different users (e.g., a sample group or test set) for which data is accessible using the identification from the single user satisfying a threshold. For example, if the identification from the single user successfully allows a predefined number of other test users (e.g., 2 users, 10 users, 100 users, 1000 users, 50% of test users, 75% of test users, and/or another predefined threshold number of test users) to access their data from a third-party service provider 108, the test module 318 may provide instructions based on the identification to more users (e.g., all or substantially all users, or the like).

In certain embodiments, the test module 318 may successively increase a test size comprising a number of users to which the test module 318 provides instructions for accessing their data from a third-party service provider 108 using an identification from a single user (e.g., starting with one or more test users, increasing to two or more, three or more, four or more, five or more, ten or more, twenty or more, thirty or more, forty or more, fifty or more, one hundred or more, five hundred or more, one thousand or more, five thousand or more, ten thousand or more, one hundred thousand or more, a million or more, and/or other successively increasing numbers of test users). The test module 318, in one embodiment, includes instructions based on an identification from a single user in an ordered list of multiple different sets of instructions for accessing a server 108 of a third-party service provider 108, as described in greater detail below with regard to the hierarchy module 312.

The test module 318, in certain embodiments, is configured to prioritize identifications from one or more users based on one or more trust factors for the one or more users (e.g., scores or the like). A trust factor, in one embodiment, may comprise a score or other metadata indicating a likelihood that a user's identification is correct. For example, in various embodiments, a trust factor may include and/or be based on one or more of a history of a user's previous identifications (e.g., correct or incorrect), a user's affiliation with a provider (e.g., a creator, a vendor, an owner, a seller, a reseller, a manufacturer, the backend server 110, or the like) of the one or more enterprise transaction modules 104, positive and/or negative indicators (e.g., votes, likes, uses, feedback, stars, endorsements, or the like) from other users, and/or other indicators of whether or not a user's identification is likely to be correct. The test module 318 may determine how many other users to provide a user's identification based on one or more trust factors associated with the user (e.g., accelerating a rate at which a user's identification is provided to other users in response to a higher trust factor, decreasing a rate at which a user's identification is provided to other users in response to a lower trust factor, or the like).

The test module 318 may provide an override interface, allowing an administrator, moderator user, or the like to remove an identification, adjust and/or override an identification, adjust and/or override a trust factor for a user, ban a user from providing identifications, and/or otherwise override a user or a user's identification. In various embodiments, the test module 318 may provide an override interface to an administrator and/or moderator as a GUI, an API, a CLI, or the like.

In certain embodiments, the test module 318 causes the one or more enterprise transaction modules 104 and their aggregation services to be self-healing, self-testing, and/or self incrementally deploying, as it tests and uses the most effective solutions, or the like (e.g., sets of instructions based on indications from one or more users).

In one embodiment, the ruleset module 320 is configured to determine and/or use a ruleset for categorizing financial transactions based on accounting categories determined by a categorization module 204, so that the categorization module 204 may determine accounting categories for subsequent financial transactions using the determined ruleset from the ruleset module 320. For example, a ruleset module 320 may determine a ruleset for a categorization module 204 comprising rules and/or other instructions or indicators mapping elements of a metadata record from a metadata module 202 to an accounting category of a categorization module 204. A ruleset may include an index, a mapping structure, a function, a tree, or the like that receives one or more elements of a metadata record and outputs an accounting category.

A ruleset module 320 may base mappings from metadata records to accounting categories, in various embodiments, on user input (e.g., a user defining an accounting category for a financial transaction), on public records for an identified party to a financial transaction (e.g., state records for a business entity, a website for a business entity, or the like), on which employee or other user made the financial transaction, on a machine learning and/or other artificial intelligence analysis of financial transactions for a plurality of business entities or other users, on a machine learning and/or other artificial intelligence analysis of one or more websites for an identified party to a financial transaction, on item-level data determined for a financial transaction (e.g., as described below with regard to the item-level module 330), or the like.

In some embodiments, a ruleset module 320 may standardize mappings for multiple users (e.g., multiple business entities) based on merchants or other parties to the financial transactions (e.g., using similar mappings for each financial transaction with the same merchant or other party). In one embodiment, a ruleset module 320 may provide a user interface allowing a user to customize mappings from dynamically selectable combinations of different elements of metadata records (e.g., a transaction amount, a transaction date, a spending category, an entity identifier, a classification of whether a financial transactions is a recurring transaction and/or subscription, an account identifier, a transaction type, and/or other metadata for a financial transaction) to dynamically selectable accounting categories, providing flexible custom mapping options for complex accounting.

In one embodiment, an override module 322 may be configured to provide an interface for a user (e.g., a user associated with a business entity or the like) to override an accounting category for one of more financial transactions (e.g., to select a different accounting category for the one or more financial transactions than a categorization module 204 would otherwise determine). An override module 322, in some embodiments, may enforce an override from a user for one or more subsequent financial transactions with similar metadata records to an overridden transaction (e.g., metadata records that match at least a predefined portion of the metadata records, such as elements of the metadata record selected by the user for the override, or the like). In certain embodiments, a categorization module 204 may use one or more overrides from one user/business entity in order to determine an accounting category for one or more financial transactions of a different user/business entity (e.g., in response to at least a threshold number of users/business entities selecting the same override, or the like).

In one embodiment, a prediction module 324 may be configured to monitor financial transactions, metadata records, and/or accounting categories of a business entity in order to predict a future event for the business entity (e.g., in order for the offer module 206 to select a financial product based on the predicted event, or the like). For example, a prediction module 324 may monitor accounts payable and accounts receivable, account balances, profits and losses, or the like, to predict an event such as a future shortfall of funds, a negative account balance, a future breach of a financial covenant for a loan or other account, a future excess of funds, or the like based on historical transaction data. A prediction module 324, in various embodiments, may predict an event by processing transaction data, metadata records, and/or accounting categories using predictive analytics, machine learning or other artificial intelligence, or the like.

In one embodiment, an output module 326 is configured to determine and/or provide one or more outputs to a user based on financial transaction data, metadata records, and/or accounting categories (e.g., so the output may be sent by a communication module 208, displayed by a display module 210, or the like). For example, in various embodiments, an output module 326 may process financial transaction data, metadata records, and/or accounting categories to determine an offer for a financial product of a financial institution (e.g., in cooperation with an offer module 206), a general ledger, a profit and loss statement, elements of a governmental tax form, a risk analysis, a credit score or other indicator of credit worthiness, or the like. An output module 326 may provide a determined output to a communication module 208 (e.g., to transmit to another enterprise transaction module 104, to a hardware device 102, to a third-party server 108, to a backend server 110, or the like. For example, an output module 326 may electronically submit (e.g., using a communication module 208 or the like) one or more governmental tax forms to a governmental hardware computer device 108 using an Application Programming Interface (API) of the governmental hardware computer device 108, or the like.

In one embodiment, an approval module 328 is configured to prompt a user on an electronic display of a hardware device 102 for approval of a payment, for acceptance of an offer, for authorization to submit a governmental tax form, or the like. For example, in some embodiments, an approval module 328 may prompt a user for approval for an accounts payable financial transaction in response to a categorization module 204 (e.g., disposed on a hardware computer server 110) determining an accounts payable accounting category for the accounts payable financial transaction (e.g., so that an enterprise transaction module 104 may automatically make the payment in response to input from the user approving the payment, or the like).

An approval module 328 may cooperate with a display module 210 to prompt a user on an electronic display of a hardware device 102 using a push notification, a graphical user interface (e.g., of a mobile application or other computer executable code), an email, a text message, or the like.

In one embodiment, an item-level module 330 may be configured to cooperate with the categorization module 204 to determine different accounting categories for different items from the same financial transaction by downloading item-level data for the financial transaction from a third-party hardware server 108 of a third-party that is a party to the financial transaction (e.g., a vendor, merchant, service provider, or the like). An item-level module 330 may use electronic credentials for a business entity or other user to login to an account of the business entity or other user with the third party to download the item-level data.

In one embodiment, an item-level module 330 is configured to determine and/or receive a user's electronic credentials (e.g., username and password, fingerprint scan, retinal scan, digital certificate, personal identification number (PIN), challenge response, security token, hardware token, software token, DNA sequence, signature, facial recognition, voice pattern recognition, bio-electric signals, two-factor authentication credentials, or the like) for one or more third party service providers 108. The item-level module 330, in certain embodiments, accesses a server 108 of a third party service provider 108 using a user's electronic credentials to download data associated with the user from the server 108, such as a user's purchase history, a user's photos, a user's social media posts, a user's medical records, a user's financial transaction records or other financial data, and/or other data associated with and/or owned by a user but stored by a server 108 of a third party service provider 108 (e.g., stored by hardware not owned, maintained, and/or controlled by the user). The item-level module 330, in various embodiments, may provide the downloaded data to the user locally (e.g., displaying the data on an electronic display of a hardware device 102); may provide the downloaded data from the hardware device 102 of the user to a remote server 110 (e.g., a backend item-level module 330) which may be unaffiliated with the third party service provider 108; may provide one or more alerts, messages, advertisements, or other communications to the user (e.g., on a hardware device 102) based on the downloaded data; or the like.

The item-level module 330, in one embodiment, downloads and/or aggregates item level data from one or more third party service providers 110. In certain embodiments, item level data comprises identification of one or more sub-items that form part of a larger item. For example, item level data may comprise identifiers for one or more individual items (e.g., goods and/or services) which a user purchased within a larger, single transaction. An item level identifier for one or more individual items may include one or more of the item's name, stock keeping unit (SKU) identifier, universal product code (UPC), international article number (EAN), global trade item number (GTIN), or the like.

Item level data, in certain embodiments, may not be available from certain third-party service providers 108. For example, a financial institution 108 may provide the item-level module 330 with a list of one or more transactions, including one or more of a date, an amount, a location or vendor, or the like for each transaction, but without any item level information for items within a transaction. In order to download and/or aggregate item level data, in one embodiment, the item-level module 330 may use a user's electronic credentials to access a third party service provider 108 associated with an identified transaction, such as an online shopping website; an audio, video, and/or other digital media website; a loyalty and/or rewards website for a retail store; or the like, to access and download item level information for items within a transaction (e.g., by accessing the user's purchase history, transaction history, order history, account history, viewing or listening history, or the like).

For example, the item-level module 330 may download item level data comprising movies and/or television shows purchased and/or viewed, eBooks purchased and/or read, or the like from a digital media provider's website, such as Apple® iTunes®, Google® Play®, Netflix®, Hulu®, Amazon®, or the like. The item-level module 330 may download item level data comprising physical goods or other items purchased from an online retailer's website, such as Amazon® or the like. The item-level module 330 may download item level data comprising menu items ordered from a restaurant's loyalty and/or rewards website; may download item level data for individual goods purchased from a grocery store, department store, hardware store, or the like's loyalty and/or rewards website, from a store credit card account website, or the like.

The item-level module 330 may automatically click or select one or more individual items within a listed history, and download the resulting item level data for the item, returning to the listed history and repeating for each listed item or the like, using an access pattern and/or screen scrape as described in greater detail below. In certain embodiments, in response to determining that item level data for a transaction is not available from a third party service provider 108 and/or in response to a request from a user, the item-level module 330 may use a camera of a hardware device 102, a scanner, or the like to photograph and/or scan a paper receipt from a third party service provider 108, and may use optical character recognition to determine item level data from the receipt, instead of and/or in addition to downloading item level data from one or more third party service providers 108.

In one embodiment, the item-level module 330 may correlate downloaded and/or aggregated transaction data that does not have item level data (e.g., from a financial institution, from a financial transaction data aggregation server 104b, or the like) with item level data downloaded and/or aggregated from a particular third party service provider 108 with which the transaction occurred. For example, the item-level module 330 may match a location and/or vendor identifier or portion thereof listed in transaction data, with the actual third party service provider 108 with which the transaction occurred, access item level data from the third party service provider 108, and match the transaction data to the item level data based on a transaction amount, a transaction date, a transaction location, a product image, a product link, a number of items, or the like. The item-level module 330 may present the item level data to the user within a personal financial management interface, allowing the user to view a transaction history, with item level data for individual transactions, may categorize a transaction (e.g., for inclusion in a budget or the like) based on the item level data, may provide a recommendation and/or advertisement based on the item level data, and/or otherwise provide the item level data to the user.

In one embodiment, a deduplication module 332 is configured to deduplicate manually entered financial transactions and electronically generated financial transactions based on metadata records from a metadata module 202, or the like. For example, a deduplication module 332 may combine, consolidate, and/or delete data for a duplicate financial transaction (e.g., in response to at least a predetermined amount of the metadata records for the duplicate financial transaction matching, or the like). A deduplication module 332, may compare one or more determined attributes from metadata records (e.g., entity names, transaction dates, transaction amounts, accounting categories, or the like). In this manner, in certain embodiments, a deduplication module 332 may ensure that records are accurate and accounts reconcile even if a user manually enters a financial transaction that is also electronically recorded.

In a further embodiment, a deduplication module 332 may automatically match payment transactions to accrual transactions, or the like (e.g., for purposes of accounting rather than deduplication). For example, a deduplication module 332 may process metadata records to match entity names, amounts, or the like from payment transactions with accrual transactions, account receivable transactions, or the like, and may mark matching transactions as related.

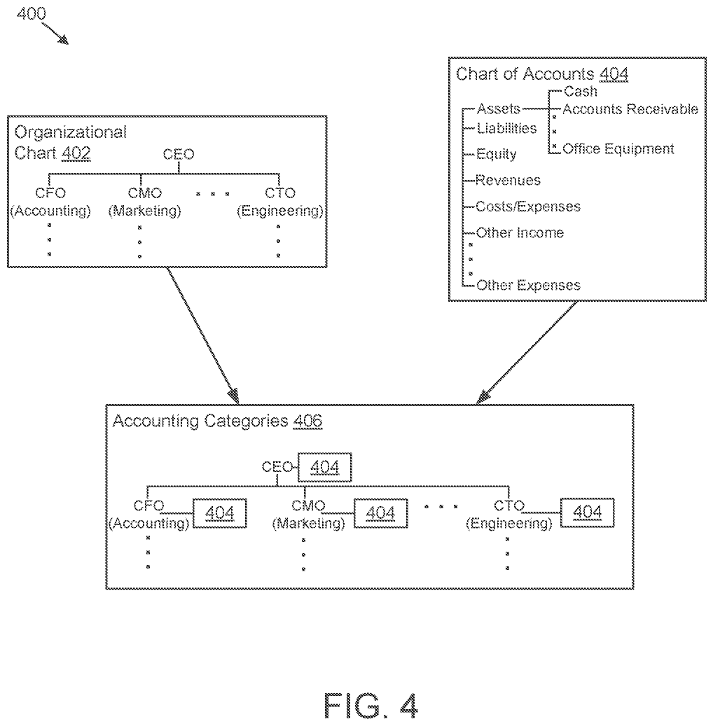

FIG. 4 depicts one embodiment of a system 400 comprising an organizational chart 402, a chart of accounts 404, and accounting categories 406. In the depicted embodiment, a categorization module 204 combines a hierarchical organizational chart 402 for a business entity with a chart of accounts 404, to create accounting categories 406 for financial transactions of the business entity. In the depicted embodiment, a categorization module 204 has duplicated the chart of accounts 404 for different entries in the hierarchical organizational chart 402 (e.g., for different executives, departments, or the like). As described above with regard to the categorization module 204, in various embodiments, a hierarchical organizational chart 402 and/or a chart of accounts 404 may be defaults provided by the categorization module 204, may be customized for a business entity by a user, or the like.

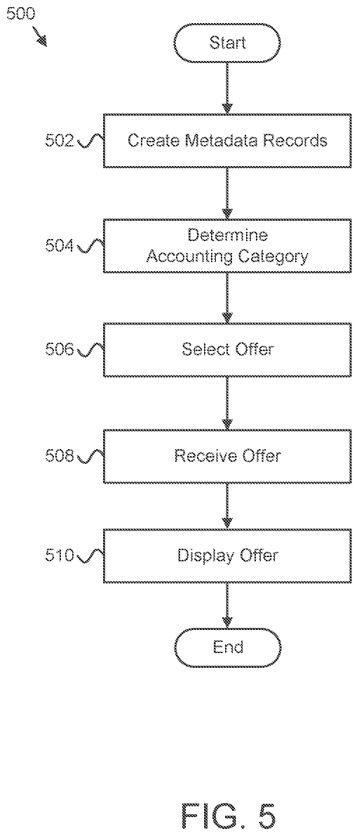

FIG. 5 depicts one embodiment of a method 600 for automated enterprise transaction data aggregation and accounting. The method 500 begins and a metadata module 202 creates 502 metadata records for a plurality of financial transactions for one or more financial accounts of a company (e.g., including at least one financial account held for the company by the financial institution, or the like).

A categorization module 204 determines 504 an accounting category for the financial transactions based on the created 502 metadata records. An offer module 206 selects 506 an offer for a financial product of the financial institution based on the determined 504 accounting categories and/or the created 502 metadata records.

A communication module 208 receives 508 the selected 506 offer for the financial product of the financial institution from a network interface of a hardware computer server 110 using a network interface of a hardware device 102 of the user. A display module 210 displays 510 the received 508 offer for the financial product of the financial institution to the user on an electronic display of the hardware device 102 of the user and the method 500 ends.

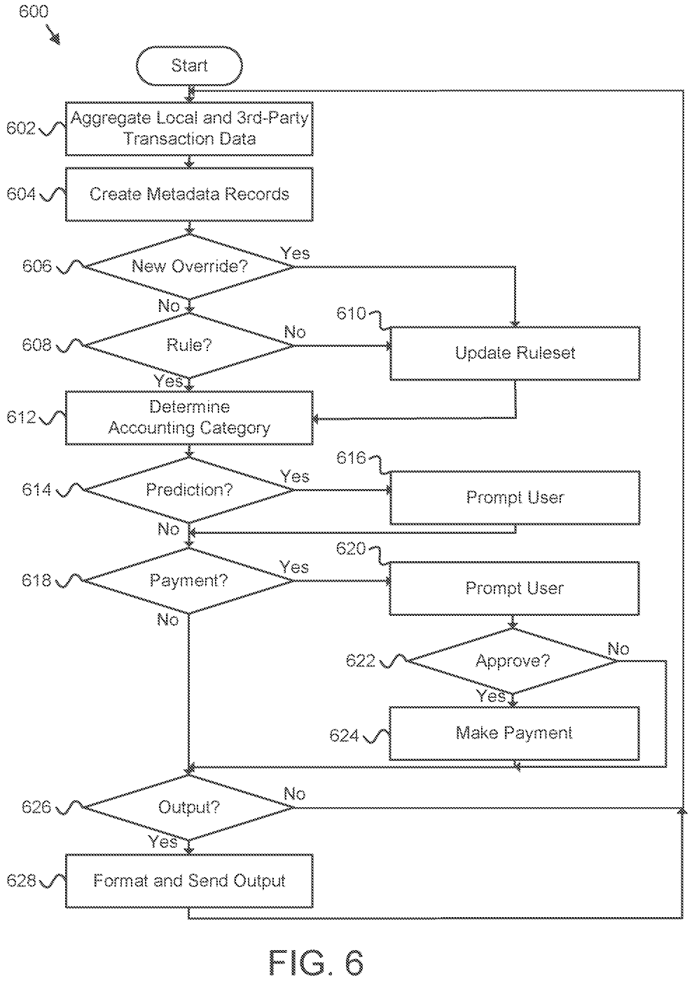

FIG. 6 depicts one embodiment of a method 600 for automated enterprise transaction data aggregation and accounting. The method 600 begins and a direct access module 307 (e.g., disposed on a hardware computer server of a third-party data aggregator 108, on a backend hardware computer server 110 of a financial institution, on a user's hardware device 102, or the like) aggregates 602 local and/or third-party financial transaction data for a business entity. A metadata module 202 creates 604 metadata records for the aggregated 602 financial transaction data.

An override module 322 determines 606 whether a user has an override for mapping a financial transaction to an accounting category. If the override module 322 determines 606 that the user has an override, a ruleset module 320 updates 610 a ruleset for mapping financial transactions to accounting categories with the override. A categorization module 204 determines 612 an accounting category for an aggregated 602 financial transaction using the ruleset from the ruleset module 320.

A prediction module 324 determines 614 whether there is a prediction for the business entity (e.g., a predicted shortfall, negative balance, breach of a financial covenant, or the like). If the prediction module 324 determines 614 that there is a prediction for the business entity, an approval module 328 prompts 616 a user of the prediction (e.g., to notify the user, receive approval from the user for a remedy, an offer for a financial product, or the like).

An approval module 328 determines 618 whether the financial transaction is an accounts payable transaction. If the approval module 328 determines 618 that the financial transaction is an accounts payable transaction, the approval module 328 prompts 620 a user for approval to automatically make the payment. If the user approves 622 the payment, an output module 326 makes 624 the payment.

The output module 326 determines 626 whether a user has requested additional output (e.g., a general ledger, a profit and loss statement, elements of a governmental tax form, a risk analysis, a credit score or other indicator of credit worthiness, or the like). If the output module 326 determines 626 that the user has requested additional output, the output module 326 formats and sends the requested output (e.g., a general ledger, a profit and loss statement, elements of a governmental tax form, a risk analysis, a credit score or other indicator of credit worthiness, or the like) to the requested destination (e.g., a hardware device 102 of a user, a third-party hardware computer server 108 such as a governmental hardware computer device 108, or the like, in cooperation with a communication module 208. The method 600 continues for subsequently aggregated 602 financial transaction data.

A means for creating metadata records for a plurality of financial transactions for one or more financial accounts of a business entity, in various embodiments, may include one or more of a hardware device 102, a backend server 110, a third-party server 108, an enterprise transaction module 104, a metadata module 202, a processor (e.g., a central processing unit (CPU), a processor core, a field programmable gate array (FPGA) or other programmable logic, an application specific integrated circuit (ASIC), a controller, a microcontroller, and/or another semiconductor integrated circuit device), a hardware appliance or other hardware device, other logic hardware, and/or other executable code stored on a computer readable storage medium. Other embodiments may include similar or equivalent means for creating metadata records for a plurality of financial transactions for one or more financial accounts of a business entity.

A means for determining an accounting category for financial transactions based on metadata records, in various embodiments, may include one or more of a hardware device 102, a backend server 110, a third-party server 108, an enterprise transaction module 104, a categorization module 204, a ruleset module 320, an override module 322, a processor (e.g., a central processing unit (CPU), a processor core, a field programmable gate array (FPGA) or other programmable logic, an application specific integrated circuit (ASIC), a controller, a microcontroller, and/or another semiconductor integrated circuit device), a hardware appliance or other hardware device, other logic hardware, and/or other executable code stored on a computer readable storage medium. Other embodiments may include similar or equivalent means for determining an accounting category for financial transactions based on metadata records.

A means for selecting an offer for a financial product of a financial institution based on determined accounting categories and/or created metadata records, in various embodiments, may include one or more of a hardware device 102, a backend server 110, a third-party server 108, an enterprise transaction module 104, an offer module 206, a processor (e.g., a central processing unit (CPU), a processor core, a field programmable gate array (FPGA) or other programmable logic, an application specific integrated circuit (ASIC), a controller, a microcontroller, and/or another semiconductor integrated circuit device), a hardware appliance or other hardware device, other logic hardware, and/or other executable code stored on a computer readable storage medium. Other embodiments may include similar or equivalent means for selecting an offer for a financial product of a financial institution based on determined accounting categories and/or created metadata records.

A means for displaying an offer for a financial product of a financial institution to a user associated with one or more financial accounts, in various embodiments, may include one or more of an electronic display screen, a hardware device 102, a backend server 110, a third-party server 108, an enterprise transaction module 104, a communications module 208, a display module 210, an output module 326, an approval module 328, a processor (e.g., a central processing unit (CPU), a processor core, a field programmable gate array (FPGA) or other programmable logic, an application specific integrated circuit (ASIC), a controller, a microcontroller, and/or another semiconductor integrated circuit device), a hardware appliance or other hardware device, other logic hardware, and/or other executable code stored on a computer readable storage medium. Other embodiments may include similar or equivalent means for displaying an offer for a financial product of a financial institution to a user associated with one or more financial accounts.

Means for performing the other method steps described herein, in various embodiments, may include one or more of a hardware device 102, a backend server 110, a third-party server 108, an enterprise transaction module 104, an authentication module 301, a local authentication module 302, a network authentication module 304, a password manager module 306, a direct access module 307, a pattern module 308, an access repair module 310, a hierarchy module 312, a metadata module 202, a categorization module 204, an offer module 206, a communication module 208, a display module 210, an interface module 313, a route module 314, a frequency module 316, a test module 318, a ruleset module 320, an override module 322, a prediction module 324, an output module 326, an approval module 328, an item-level module 330, a deduplication module 332, a processor (e.g., a central processing unit (CPU), a processor core, a field programmable gate array (FPGA) or other programmable logic, an application specific integrated circuit (ASIC), a controller, a microcontroller, and/or another semiconductor integrated circuit device), a hardware appliance or other hardware device, other logic hardware, and/or other executable code stored on a computer readable storage medium. Other embodiments may include similar or equivalent means for performing one or more of the method steps described herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a hardware computer server for a financial institution, the hardware computer server comprising a network interface and configured to:
create metadata records for a plurality of financial transactions for one or more financial accounts of a business entity, the one or more financial accounts including at least one financial account held for the business entity by the financial institution,
determine an accounting category for each of the financial transactions based on the metadata records, and
select an offer for a financial product of the financial institution based on the determined accounting categories and the created metadata records; and
computer executable program code installed on a non-transitory computer readable storage medium of a hardware device of a user associated with the one or more financial accounts, the hardware device comprising an electronic display and a network interface, the executable program code comprising operations configured to:
receive the offer for the financial product of the financial institution from the network interface of the hardware computer server using the network interface of the hardware device of the user, and
display the offer for the financial product of the financial institution to the user on the electronic display of the hardware device of the user.

2. The apparatus of claim 1, wherein the hardware computer server is further configured to determine a ruleset for categorizing financial transactions based on the determined accounting categories and to determine an accounting category for subsequent financial transactions using the determined ruleset.

3. The apparatus of claim 1, wherein the hardware computer server is further configured to provide an interface for the user to override the determined accounting category for one of more of the financial transactions and to enforce the override for one or more subsequent financial transactions with metadata records that match at least a predefined portion of the metadata records for the one or more of the financial transactions with the overridden accounting category.

4. The apparatus of claim 1, wherein the hardware computer server is further configured to predict a future shortfall of funds for the business entity based on the plurality of financial transactions and the offer for the financial product comprises an offer for a bridge loan from the financial institution to the business entity.

5. The apparatus of claim 4, wherein an amount of the bridge loan is selected to cover the predicted future shortfall and to be paid back by funds from one or more financial transactions from the plurality of financial transactions determined to be in an accounts payable accounting category.

6. The apparatus of claim 1, wherein the hardware computer server is further configured to predict a future breach of a financial covenant of the business entity for one financial account of the one or more financial accounts of the business entity and the offer for the financial product comprises an offer for one or more of an amended financial covenant for the one financial account and a new financial account with a different financial covenant.

7. The apparatus of claim 1, wherein the hardware computer server is further configured to predict that an account of the one or more financial accounts will have a negative balance based on the plurality of financial transactions, and to one or more of:
notify the user on the electronic display of the hardware device of the user; and
transfer funds from a different account of the one or more financial accounts to the account predicted to have the negative balance.

8. The apparatus of claim 1, wherein the hardware computer server is further configured to autopopulate one or more governmental tax forms for the business entity based on the plurality of financial transactions and the determined accounting categories.

9. The apparatus of claim 8, wherein the hardware computer server is further configured to electronically submit the one or more governmental tax forms to a governmental hardware computer device using an Application Programming Interface (API) of the governmental hardware computer device over the network interface of the hardware computer server in response to input from the user over the network interface of the hardware device of the user.

10. The apparatus of claim 1, wherein the operations of the computer executable program code are further configured to prompt the user on the electronic display of the hardware device for approval of a payment for an accounts payable financial transaction of the plurality of financial transactions in response to the hardware computer server determining an accounts payable accounting category for the accounts payable financial transaction and to automatically make the payment in response to input from the user approving the payment.

11. The apparatus of claim 1, wherein the hardware computer server is further configured to determine different accounting categories for different items from the same financial transaction of the plurality of transactions by downloading item-level data for the same financial transaction from a third-party hardware server of a third-party that is party to the same financial transaction.

12. The apparatus of claim 11, wherein the hardware computer server is further configured to use electronic credentials for the business entity to login to an account of the business entity with the third-party to download the item-level data.

13. The apparatus of claim 12, wherein downloading the item-level data comprises parsing one or more webpages from the third-party hardware server of the third-party to locate one or more of an invoice, an order history, and an account statement comprising at least a portion of the item-level data.

14. The apparatus of claim 1, wherein the hardware computer server is further configured to deduplicate manually entered financial transactions of the plurality of transactions and electronically generated financial transactions of the plurality of transactions based on the created metadata records.

15. The apparatus of claim 1, wherein the hardware computer server is further configured to dynamically determine one or more of a risk analysis and a credit worthiness for the business entity based on the plurality of financial transactions and the determined accounting categories.

16. The apparatus of claim 1, wherein the accounting categories are automatically derived from at least a hierarchical organizational chart for the business entity.

17. The apparatus of claim 16, wherein the accounting categories are automatically derived from both the hierarchical organizational chart for the business entity and a chart of accounts, at least a portion of the chart of accounts being duplicated for different departments in the hierarchical organizational chart.

18. The apparatus of claim 1, wherein the determined accounting categories comprise one or more of a general ledger for the business entity and a financial statement for the business entity and the operations are further configured to display the one or more of the general ledger and the financial statement to the user on the electronic display of the hardware device of the user.

19. The apparatus of claim 1, wherein the offer for the financial product comprises one or more of a better interest rate and a lower fee than an external account of the one or more financial accounts of the business entity, the external account being held by a different financial institution.

20. A computer program product comprising executable code stored by a non-transitory computer readable storage medium, the executable code comprising operations executable by a processor, the operations comprising:
creating metadata records for a plurality of financial transactions for one or more financial accounts of a business entity, the one or more accounts including at least one financial account held for the business entity by a financial institution, each metadata record comprising a transaction amount, a transaction date, a spending category, and an entity identifier for one of the plurality of financial transactions;
determining an accounting category for each of the financial transactions based on the metadata records;
selecting an offer for a financial product of the financial institution based on the determined accounting categories and the created metadata records; and
displaying the offer for the financial product of the financial institution to a user associated with the one or more financial accounts on an electronic display of a hardware device of the user.

21. The computer program product of claim 20, wherein the metadata records further comprise one or more of a classification of whether the one of the plurality of financial transactions is a recurring transaction, an account identifier, and a transaction type for the one of the plurality of financial transactions.

22. An apparatus comprising:
means for creating metadata records for a plurality of financial transactions for one or more financial accounts of a business entity, the one or more accounts including at least one financial account held for the business entity by a financial institution;
means for determining an accounting category for each of the financial transactions based on the metadata records;
means for selecting an offer for a financial product of the financial institution based on the determined accounting categories and the created metadata records; and
means for displaying the offer for the financial product of the financial institution to a user associated with the one or more financial accounts.
